(19) United States
(12) Patent Application Publication
(10) Pub. No.: US 2015/0021299 A1
(43) Pub. Date: Jan. 22, 2015

(54) Batch Methods of Forming Microscale or Millimeter Scale Structures Using Electro Discharge Machining Alone or In Combination with Other Fabrication Methods

(71) Applicant: Microfabrica Inc., Van Nuys, CA (US)

(72) Inventors: Heath A. Jensen, Los Angeles, CA (US); Uri Frodis, Los Angeles, CA (US); Christopher G. Wiita, Pasadena, CA (US); Michael S. Lockard, Lake Elizabeth, CA (US)

(21) Appl. No.: 14/333,476

(22) Filed: Jul. 16, 2014

Related U.S. Application Data
(60) Provisional application No. 61/846,745, filed on Jul. 16, 2013.

(51) Int. Cl. B23H 1/04

(52) U.S. Cl. CPC B23H 1/04
USPC 219/69.17

(57) ABSTRACT

Embodiments are directed to forming three-dimensional millimeter scale or micro-scale structures from single or multiple sheets or layers of material via electro discharge machining (EDM). In some embodiments, the electrodes are formed by single layer or multi-layer, single material or multi-material deposition processes. In some embodiments single electrodes form a plurality of parts or structures simultaneously. In some embodiments a sacrificial bridging material is used to hold parts together during and after EDM processing.

### RELATED APPLICATIONS

This application claims the benefit of U.S. Provisional Patent Application No. 61/846,745, filed Jul. 16, 2013 (Microfabrica Docket No. P-US314-A-MF). This application is incorporated herein by reference as if set forth in full herein.

### FIELD OF THE INVENTION

The present invention relates generally to the field of forming microstructures or millimeter-scale structures and in some specific embodiments more specifically to the field of forming micro-scale or millimeter-scale probes or contactors for use in electrical testing or interconnect applications such as wafer level semiconductor device testing and even more particularly to processes for forming such structures, devices, assemblies, components (i.e. parts) using electro discharge machining methods alone or in combination with laser machining methods and/or single layer or multi-layer, multi-material fabrication methods.

### BACKGROUND OF THE INVENTION

### Electrochemical Fabrication

Various methods for forming microprobes have been taught previously. Such methods include use of multi-layer, multi-material deposition processes for such formation and could result in probe bodies, or probe bodies with contact tips, being formed on permanent substrates or formed on temporary substrates from which they could be released. A draw back with such approaches relates to a limited availability of materials that can be cost effectively deposited. Examples of such methods and resulting probes can be found in a number of US Patents and US Patent Application Publications including: (1) U.S. Pat. No. 6,027,630; (2) U.S. Pat. No. 5,190,637; (3) U.S. Pat. No. 7,273,812; (4) U.S. Pat. No. 7,640,651; (5) U.S. Pat. No. 7,878,385; (6) U.S. Pat. No. 7,531,077; (7) US Patent Application Publication No. 2005-018478, (8) U.S. Pat. No. 7,265,565; (9) US Patent Application Publication No. 2008-0050534; and (10) US Patent Application Publication No, 2011-0132767. Each of these referenced patents and published applications is incorporated herein by reference.

Other proposed methods include the use of laser cutting to form probe bodies and possibly tips from sheets of material. Since different materials may be formed into sheets, these methods provide for probes formed from a variety of different materials. Such methods may however suffer from a variety of difficulties including: (1) slow processing time, (2) difficulties or complexities in integrating multiple materials into single probes, (3) difficulties in achieving uniform probe geometry or material properties due to material/laser interactions. An example of such methods and resulting probes can be found in US Patent Application Publication No. 2012/0286816. The teachings of this referenced application are incorporated herein by reference.

Still other methods have been proposed including the use of electro discharge machining (EDM) to form probe bodies. These methods like that of laser cutting can be applied to sheet materials and thus can lead to probes formed of different materials than those produced by electrochemical deposition methods. These methods may suffer from difficulties in fabricating useful EDM electrodes for batch fabrication of probes, methods for ensuring stable workpiece control during machining and/or separation from substrates once machining is complete. An example of such a process can be found in U.S. Pat. No. 7,122,760. The teachings of this referenced patent are incorporated herein by reference.

A need still exists in the field of microprobe production, and more generally in the field of micro-device or millimeter-scale device production for improved devices/probes and methods for making such devices/probes. In particular, a need remains for miniature devices having improved characteristics, reduced fabrication times, reduced fabrication costs, simplified fabrication processes, greater versatility in device design, improved selection of materials, improved material properties, more cost effective and less risky production of such devices, and/or more independence between geometric configuration and the selected fabrication process.

### SUMMARY OF THE INVENTION

It is an object of some embodiments of the invention to provide an improved method for forming multi-layer three-dimensional structures with improved material properties, e.g. probes with improved properties that can be used for testing integrated circuits.

It is an object of some embodiments of the invention to provide an improved method for forming single layer structures with improved material properties, e.g. probes with improved properties that can be used for testing integrated circuits.

It is an object of some embodiments of the invention to provide an improved method for fabricating parts, e.g. probes, using EDM machining of sheet material.

It is an object of some embodiments of the invention to provide an improved method for fabricating parts, e.g. probes, from multiple bonded sheets of material using EDM machining.

It is an object of some embodiments of the invention to provide an improved method for fabricating parts, e.g. probes, formed from a combination of sheet material and deposited material wherein EDM machining is used to define the dimensions of the sheet material but is not used to define the dimensions of the deposited material.

It is an object of some embodiments of the invention to provide an improved method for fabricating probes formed from a combination of sheet material and deposited material wherein EDM machining is used to define the dimensions of the sheet material and part of the dimensions of the deposited material or materials.

It is an object of some embodiments of the invention to provide an improved method for fabricating parts, e.g. probes, from a combination of sheet material and deposited material wherein the EDM machining is used to define the dimensions of the sheet material and the dimensions of the deposited material or materials.

It is an object of some embodiments of the invention to provide an improved method for fabricating parts, e.g. probes, having a tip material that is different from the sheet material wherein the tip material is deposited on to the sheet material prior to patterning the sheet material.

It is an object of some embodiments of the invention to provide an improved method for fabricating parts, e.g. probes, having a tip material that is different from the sheet material wherein the tip material is deposited on to the sheet material after at least partial patterning the sheet material.

It is an object of some embodiments of the invention to provide an improved method for fabricating parts, e.g. probes, having a conductivity enhancing material that is different from the sheet material wherein the conductivity enhancing material is deposited on to the sheet material prior to patterning the sheet material.

It is an object of some embodiments of the invention to provide an improved method for fabricating parts, e.g. probes, having a conductivity enhancing material that is different from the sheet material wherein the conductivity enhancing material is deposited on to the sheet material after at least partial patterning the sheet material.

It is an object of some embodiments of the invention to provide an improved method for fabricating parts, e.g. probes, having a bonding enhancement material that is different from the sheet material wherein the bonding enhancement material is deposited on to the sheet material prior to patterning the sheet material.

It is an object of some embodiments of the invention to provide an improved method for fabricating parts, e.g. probes, having a bonding enhancement material that is different from the sheet material wherein the bonding enhancement material is deposited on to the sheet material after at least partial patterning the sheet material.

It is an object of some embodiments of the invention to provide an improved method for fabricating parts, e.g. probes, having a part body formed from at least one sheet of material and a part tip which is located on a layer different from a layer that includes the at least one sheet of material.

It is an object of some embodiments of the invention to provide an improved method for fabricating parts, e.g. probes, wherein the parts are formed at least in part from a sheet of material wherein the material of the sheet meets one or more of the following criteria: (1) the material is not electrodepositable from an aqueous solution, and (2) the material comprises a conductive refractory material.

It is an object of some embodiments of the invention to provide an improved method for fabricating parts, e.g. probes, and handling parts wherein a plurality of parts remain tethered to one another after fabrication and removal of a bridging sacrificial material but which are untethered prior to (1) assembly into an array or (2) after assembly but prior to being put to use.

It is an object of some embodiments of the invention to provide an improved method for fabricating parts, e.g. probes, wherein a coating of an additional structural material occurs in whole or in part after removal of a bridging material. In some variations, the parts are tethered together during the removal.

It is an object of some embodiments of the invention to provide improved micro-scale or millimeter scale parts, e.g. probes.

It is an object of some embodiments of the invention to provide micro-scale or millimeter-scale parts, e.g. probe devices, incorporating multiple bonded sheets of material. In some variations of this object, the one or more sheets may be EDM machined (e.g. to form openings) prior to or after bonding. In other variations, the sheets may be bonded without an intermediate bonding material. In still other variations the sheets may be bonded using one or more intermediate materials located between the sheets.

It is an object of some embodiments of the invention to provide micro-scale or millimeter-scale parts, e.g. probe devices, incorporating a combination of EDM machined sheet material and deposited material (e.g. blanket deposited, lithographically patterned, or laser patterned).

It is an object of some embodiments of the invention to provide improved methods for fabricating micro-scale or millimeter parts, e.g. probes, using improved part stabilization during the entire EDM machining process.

It is an object of some embodiments of the invention to provide improved methods for fabricating micro-scale or millimeter-scale parts or devices that are not probes.

Other objects and advantages of various embodiments of the invention will be apparent to those of skill in the art upon review of the teachings herein. The various embodiments of the invention, set forth explicitly herein or otherwise ascertained from the teachings herein, may address one or more of the above objects alone or in combination, or alternatively may address some other object ascertained from the teachings herein. It is not necessarily intended that all objects be addressed by any single aspect of the invention even though that may be the case with regard to some aspects.

In a first aspect of the invention a method for the batch formation of a plurality of micro-scale or millimeter-scale parts includes: (a) processing data representing a layout of the plurality of parts and using the data in the process of fabricating at least one EDM electrode; (b) providing a sheet of structural material having a front side and a backside; (c) locating a bridging sacrificial material on to the backside of the sheet of structural material; (e) preparing the sheet of structural material and the bridging sacrificial material for EDM processing; (f) using the at least one EDM electrode to erode or cut selected portions of the sheet so that structural material remains having a configuration of the plurality of parts and such that the plurality of parts remain in place with respect to one another due at least to the presence of the bridging sacrificial material; and (g) removing the bridging sacrificial material.

In a second aspect of the invention a method for the batch formation of a plurality of micro-scale or millimeter-scale parts, includes: (a) obtaining at least one EDM electrode representing a layout of the parts to be formed; (b) providing a sheet of structural material having a front side and a backside; (c) locating a bridging sacrificial material on to the backside of the sheet of structural material; (d) preparing the sheet of structural material and the bridging sacrificial material for EDM processing; (e) using the at least one EDM electrode to erode or cut selected portions of the sheet so that structural material remains having a configuration of the plurality of parts and such that the plurality of parts remain in place with respect to one another due at least to the presence of the bridging sacrificial material; and (f) removing the bridging sacrificial material.

In a third aspect of the invention a method for the batch formation of a plurality of micro-scale or millimeter-scale parts, includes: (a) obtaining at least one EDM electrode representing a layout of the parts to be formed; (b) providing a sheet of structural material having a front side and a backside; (c) forming at least one multi-material electrochemically fabricated layer on the backside of the sheet of structural material, wherein the at least one multi-material layer includes at least one structural material and at least one sacrificial material; (d) preparing the sheet of structural material and at least one backside multi-material layer for EDM processing; (e) using the at least one EDM electrode to erode or cut selected portions of the sheet so that structural material remains having a configuration of the plurality of parts and such that the plurality of parts remain in place with respect to one another due at least to the presence of the at least one sacrificial material of the at least one backside multi-material layer; and (f) removing the sacrificial material.

In a fourth aspect of the invention a method for the batch formation of a plurality of micro-scale or millimeter-scale parts, includes: (a) obtaining at least one EDM electrode representing a layout of the parts to be formed; (b) providing a sheet of structural material having a front side and a backside; (c) forming at least one multi-material electrochemically fabricated layer on the backside of the sheet of structural material, wherein the at least one multi-material layer comprises at least one structural material and at least one sacrificial material; (d) locating a bridging sacrificial material on to the backside of the at least one multi-material layer; (e) preparing the sheet of structural material, the at least one multi-material layer and the bridging sacrificial material for EDM processing; (f) using the at least one EDM electrode to erode or cut selected portions of the sheet and multi-material layer so that structural material remains having a configuration of the plurality of parts and such that the plurality of parts remain in place with respect to one another due at least to the presence of the bridging sacrificial material; and (g) removing the sacrificial material forming part of the at least one multi-material layer and removing bridging sacrificial material.

In a fifth aspect of the invention a method for the batch formation of a plurality of micro-scale or millimeter-scale parts, includes: (a) obtaining at least one EDM electrode representing a layout of the parts to be formed; (b) providing a sheet of structural material having a front side and a backside; (c) forming at least one structural material layer on the backside of the sheet of structural material; (d) locating a bridging sacrificial material on to the backside of the formed structural material layer; (e) preparing the sheet of structural material, the formed structural material layer, and the bridging sacrificial material for EDM processing; (f) using the at least one EDM electrode to erode or cut selected portions of the sheet and the formed structural material layer so that structural material remains having a configuration of the plurality of parts and such that the plurality of parts remain in place with respect to one another due at least to the presence of the bridging sacrificial material; and (g) removing bridging sacrificial material.

In a sixth aspect of the invention a method for the batch formation of a plurality of micro-scale or millimeter-scale parts, includes: (a) obtaining at least one EDM electrode representing a layout of the parts to be formed; (b) providing a sheet of structural material having a front side and a backside; (c) forming at least one multi-material electrochemically fabricated layer on the front side of the sheet of structural material, wherein the at least one multi-material layer comprises at least one structural material and at least one sacrificial material; (d) locating a bridging sacrificial material on to the backside of the sheet of structural material; (e) preparing the sheet of structural material and at least one backside multi-material layer for EDM processing; (f) using the at least one EDM electrode to erode or cut selected portions of the multi-material layer on the front side and the sheet so that structural material remains having a configuration of the plurality of parts and such that the plurality of parts remain in place with respect to one another due at least to the presence of the sacrificial bridging material; and (g) removing the bridging sacrificial material.

In a seventh aspect of the invention a method for the batch formation of a plurality of micro-scale or millimeter-scale parts, includes: (a) obtaining at least one EDM electrode representing a layout of the parts to be formed; (b) providing a sheet of structural material having a front side and a backside; (c) forming at least one structural material layer on the front side of the sheet of structural material; (d) locating a bridging sacrificial material on to the backside of the structural sheet material; (e) preparing the structural material layer, the sheet of structural material, and the bridging sacrificial material for EDM processing; (f) using the at least one EDM electrode to erode or cut selected portions of the deposited structural material on the front side and the sheet structural material so that structural material remains having a configuration of the plurality of parts and such that the plurality of parts remain in place with respect to one another due at least to the presence of the bridging sacrificial material; and (g) removing bridging sacrificial material.

In an eighth aspect of the invention a method for the batch formation of a plurality of micro-scale or millimeter-scale parts, includes: (a) obtaining at least one EDM electrode representing a layout of the parts to be formed; (b) providing a sheet of structural material having a front side and a backside; (c) forming at least one front side multi-material electrochemically fabricated layer on the front side of the sheet of structural material, wherein the at least one front side multi-material layer comprises at least one front side structural material and at least one front side sacrificial material; (d) forming at least one back side multi-material electrochemically fabricated layer on the backside of the sheet of structural material, wherein the at least one multi-material layer comprises at least one backside structural material and at least one backside sacrificial material; (e) preparing the sheet of structural material and the at least one front side and backside multi-material layers for EDM processing; (f) using the at least one EDM electrode to erode or cut selected portions of the at least one front side multi-material layer and the sheet structural material so that structural material remains having a configuration of the plurality of parts and such that the plurality of parts remain in place with respect to one another due at least to the presence of the at least one backside sacrificial material; and (g) removing the front side and backside sacrificial materials.

In a ninth aspect of the invention a method for the batch formation of a plurality of micro-scale or millimeter-scale parts, includes: (a) obtaining at least one EDM electrode representing a layout of the parts to be formed; (b) providing a sheet of structural material having a front side and a backside; (c) forming at least one front side multi-material electrochemically fabricated layer on the front side of the sheet of structural material, wherein the at least one front side multi-material layer comprises at least one front side structural material and at least one front side sacrificial material; (d) forming at least one back side multi-material electrochemically fabricated layer on the backside of the sheet of structural material, wherein the at least one multi-material layer comprises at least one backside structural material and at least one backside sacrificial material; (e) locating a bridging sacrificial material on to the backside of the formed structural material layer; (f) preparing the sheet of structural material, the at least one front side and backside multi-material layers, and the bridging sacrificial material for EDM processing; (g) using the at least one EDM electrode to erode or cut selected portions of at least the at least one front side multi-material layer and the sheet structural material so that structural material remains having a configuration of the plurality of parts and such that the plurality of parts remain in place with respect to one another due at least to the presence of the sacrificial bridging material; and (h) removing the front side, backside sacrificial material and the sacrificial bridging material.

In a tenth aspect of the invention a method for the batch formation of a plurality of micro-scale or millimeter-scale parts, includes: (a) obtaining at least one EDM electrode representing a layout of the parts to be formed; (b) providing a sheet of structural material having a front side and a backside; (c) forming at least one front side multi-material electrochemically fabricated layer on the front side of the sheet of structural material, wherein the at least one front side multi-material layer includes at least one front side structural material and at least one front side sacrificial material; (d) forming at least one structural material layer on the backside of the sheet of structural material; (e) locating a bridging sacrificial material on to the backside of the formed structural material layer; (f) preparing the sheet of structural material, the multi-material layer, the formed structural material layer, and the sacrificial bridging material for EDM processing; (g) using the at least one EDM electrode to erode or cut selected portions of the multi-material layer, the sheet, and the formed structural material layer so that structural material remains having a configuration of the plurality of parts and such that the plurality of parts remain in place with respect to one another due at least to the presence of the bridging sacrificial material; and (h) removing the sacrificial material from the multi-material layer and the bridging sacrificial material.

In an eleventh aspect of the invention a method for the batch formation of a plurality of micro-scale or millimeter scale parts includes: (a) obtaining at least one EDM electrode representing a layout of the parts to be formed; (b) providing a sheet of structural material having a front side and a backside; (c) forming at least one structural material layer on the front side of the sheet of structural material; (d) locating a bridging sacrificial material on to the backside of the sheet of structural material; (e) preparing the structural material layer, the sheet of structural material, and the bridging sacrificial material for EDM processing; (f) using the at least one EDM electrode to erode or cut selected portions of the formed structural material layer and the sheet so that structural material remains having a configuration of the plurality of parts and such that the plurality of parts remain in place with respect to one another due at least to the presence of the bridging sacrificial material; and (g) removing bridging sacrificial material.

In a twelfth aspect of the invention a method for the batch formation of a plurality of micro-scale or millimeter scale parts includes: (a) obtaining at least one EDM electrode representing a layout of the parts to be formed; (b) providing a sheet of structural material having a front side and a backside; (c) locating and attaching at least two layers directly or indirectly to the sheet of structural material, wherein the at least two layers are selected from the group consisting of (1) a second sheet layer of structural material, (2) at least one deposited multi-material layer, (3) at least one deposited single material layer, and (4) at least one bridging sacrificial material layer as a final layer opposite to an EDM processing direction; wherein the positioning order of stacking of the layers is selected from the group consisting of (1) the at least two layers are below the structural sheet material, (2) the at least two layers are above the structural sheet material layer, (3) a portion of the at least two layers are above the sheet material and a portion of the at least two layers are below the sheet material, (4) multiple layers of at least one type are used and are separated by a layer of another type, (5) multiple layers of at least one type are used and are adjacent to one another; (d) preparing the sheet of structural material and the located and attached layers for EDM processing; (e) using the at least one EDM electrode to erode or cut selected portions of the sheet and the at least two other layers so that structural material remains having a configuration of the plurality of parts and such that the plurality of parts remain in place with respect to one another due at least to the presence of a sacrificial material; and (f) removing sacrificial material.

In a thirteenth aspect of the invention a method for forming an EDM electrode for use in batch formation of a plurality of micro-scale or millimeter-scale parts includes: (A) forming a layer including at least two materials one of which includes at least one sacrificial material and the other of which includes at least one structural material, including: (i) depositing a first of the at least two materials in a first lateral region; (ii) depositing a second of the at least two materials in a second lateral region; (iii)) planarizing the first and second materials to set a boundary level for the layer; and (B) separating at least a portion of the sacrificial material from the structural material; (C) coating the structural material with a layer of dielectric material having a thickness selected from the group consisting of (1) less than 5 um, (2) less than 2 um, (3) less than 1 um, and (4) less than 0.5 um); and (D) removing the dielectric material from at least some horizontal surfaces of the structure while leaving the dielectric material on at least a portion of side facing surfaces of the structure.

In a fourteenth aspect of the invention a method for forming an EDM electrode for use in batch formation of a plurality of micro-scale or millimeter-scale parts includes: (A) forming a plurality of successively formed layers, wherein each successive layer comprises at least two materials and is formed on and adhered to a previously formed layer, one of the at least two materials is a structural material and the other of the at least two materials is a sacrificial material, and wherein each successive layer defines a successive cross-section of the three-dimensional structure, and wherein the forming of each of the plurality of successive layers includes: (i) depositing a first of the at least two materials; (ii) depositing a second of the at least two materials; (iii) planarizing the first and second materials to set a boundary level for the layer; and (B) after the forming of the plurality of successive layers, separating at least a portion of the sacrificial material from multiple layers of the structural material to reveal the three-dimensional structure.

In a fifteenth aspect of the invention to a twenty-eighth aspect of the invention, the first to fourteenth aspects are modified, respectively, such that the sheet of material is replaced by a single or multi-material layer of material which undergoes EDM processing. In still further aspects of the invention, the sheet of material in aspects one to fourteen are replaced by multiple adjacent sheets or multiple sheets with one or more intermediate single material or multi-material layers

Numerous variations of each aspect of the invention are possible and even numerous variations of other variations are possible. Some such variations are set forth in the immediately following paragraphs as examples. It will be understood by those of skill in the art the variations noted with regard to one aspect or with regard to a particular variation of an aspect are applicable the other aspects, embodiments, and variations to the extend they make sense and do not obviate all benefits of the aspects, embodiment, or variation they modify. As such it is intended that all such workable variations of each aspect, embodiment, and other variation, be considered as being set forth explicitly herein whether those variations are set forth herein as part of an embodiment, set forth herein as part of an aspect, set forth herein using the term variation or simply indicating by the context in which they are used that they represent an alternative, enhanced, or extended process operation or step or an apparatus feature or element.

Numerous variations of the first and second aspects of the invention are possible and include, for example: (1) the bridging sacrificial material comprises a metal; (2) the locating of the bridging material on the sheet of structural material includes electrodepositing the bridging sacrificial material on the sheet of structural material; (3) a complete perimeter of each part is cut through the sheet of structural material by the at least one EDM electrode; (4) at least a portion of the plurality of parts remain tethered to one another or to a structural material frame by tabs of structural sheet material after completion of EDM processing and wherein the tabs are removed after removing the bridging sacrificial material; (5) a layer of a deposited structural material is formed on the front side of the sheet of structural material prior to EDM processing and the EDM processing erodes or cuts through the deposited and sheet structural materials; (6) selective regions of deposited structural material being formed on the front side of the sheet of structural material prior to EDM processing and the EDM processing cuts completely through the deposited and sheet structural materials; (7) selective regions of deposited structural material are formed on the front side of the sheet of structural material prior to EDM processing and the EDM processing cuts completely through the sheet structural material but doesn't contact the deposited structural material and wherein the parts formed comprise regions of deposited structural material and sheet structural material; (8) at least one multi-material layer includes at least one structural material and at least one sacrificial material being formed on the front side of the sheet of structural material prior to EDM processing and the EDM operations cut through part of the deposited structural material and sacrificial material of the at least one multi-material layer and the sheet structural material; (9) at least one multi-material layer includes at least one structural material and at least one sacrificial material being formed on the front side of the sheet of structural material prior to EDM processing and the EDM processing cuts through only the deposited sacrificial material of the at least one multi-material layer and the sheet structural material; (10) after the EDM processing that cuts through the sheet of structural material, a sacrificial material is deposited to fill in the eroded regions of the sheet material and thereafter additional structural material is deposited; (11) a variation of variation 10 wherein the additional structural material is deposited as part of at least one multi-material layer that each includes at least one structural material and at least one sacrificial material; (12) a variation of variation 11 wherein after depositing the additional structural material, at least one additional EDM operation is performed to cut through at least a portion of the additional deposited material; (13) a variation of variation 11 wherein the depositing of additional structural material only locates structural material in locations intended to become part of the parts; (14) wherein the EDM electrode is fabricated and the fabricating of the EDM electrode includes an electrochemical deposition process; (15) a variation of variation 14 wherein the electrochemical deposition process for forming EDM electrodes comprises a multi-material deposition process and a planarization process; (16) a variation of variation 15 wherein the electrochemical deposition process is a multi-layer process; (17) a variation of variations 14-16 wherein the fabricating of the EDM electrode additionally includes providing a conformal coating of at least one deposited structural material with a relatively thin coating of dielectric material that is removed from outward facing surfaces and is substantially retained on side facing surfaces of the structural material; (18) a variation of variation 17 wherein the relative thin dielectric coating is less than 5 um thick and more preferably less than 2 um thick and more preferably less than 1 um thick; (19) parts include probes for use in a probe card that in turn are used for wafer level testing of semiconductor devices; (20) the parts include compliant pins for electrical connectors; (21) a variation of either variation 19 or 20 wherein the probes or pins comprise a tip material that is different from a material of the body of the probes or pins; (22) a variation of any of variations 19-21 wherein the probes or pins comprise a material in a bonding region that is different from the material of a body of the probes or pins; (23) the parts comprise multi-component devices which are formed in substantially assembled states; (24) prior to removing, the parts are inspected; (25) a variation of variation 24 wherein the parts are that are inspected and have failed the inspection are flagged for special handling; (26) a variation of variation 25 wherein the parts that are flagged for special handling are cut into two or more pieces to enable them to be readily distinguished from structures that did not fail inspection; (27) a variation of variation 26 wherein the parts that are flagged for special handling are attached to adjacent sheet material such that during release, the flagged structures are distinguishable from structures that did not fail inspection; (28) the preparing includes attaching the bridging sacrificial material to a frame; (29) a variation of variation 28 wherein the attaching of the bridging sacrificial material to the frame comprises positioning a conductive adhesive material on a surface consisting of (A) a surface of the bridging sacrificial material and (B) a surface of the frame and then bringing the surfaces of the bridging sacrificial material and the surface of the frame into proximity so as to cause attachment; (30) the preparing includes attaching the front side of the sheet of structural material, via any overlying material, to a frame; (31) a variation of variation 30 wherein the attaching of the front side of the sheet of structural material to the frame includes positioning a conductive adhesive on a surface consisting of (A) a surface of the front side of the sheet material or front side of any overlying material, and (B) a surface of the frame and then bringing the surface of the sheet or other material and the surface of the frame into proximity so as to cause attachment; (32) use of an EDM electrode to thin selected portions of the structural that will become portions of the plurality of parts; (33) thinning selected portions of the backside of the sheet of material such that at least part of the thinned portions become portions of the plurality of parts; (34) a variation of variation 33 wherein the thinning of the backside includes use of a technique selected from the group consisting of (A) EDM processing, (B) laser machining, and (C) selective etching; (35) a property of the sheet structural material being changed by treatment of the structural material after EDM occurs; (36) the at least one EDM electrode including a single electrode array that includes a plurality of different purpose electrodes that are serially stacked including at least two electrodes selected from the group consisting of (A) at least one drilling electrode to form through passages, (B) at least one rough cutting electrode that results in regions that approximate the shape of the parts but does not create part boundaries, and (C) at least one finish electrode that provides for part boundaries; (37) the EDM electrode includes through passages that allow for dielectric fluid flow and removal of erosion or cutting debris.

Numerous variations of the third aspect of the invention are possible and include, for example: (1) a complete perimeter of each part being cut through the sheet of structural material by the at least one EDM electrode; (2) at least a portion of the plurality of parts remain tethered to one another or to a structural material frame by tabs of structural sheet material after completion of EDM processing and wherein the tabs are removed after removing the sacrificial material of the at least one multi-material layer; (3) a layer of a deposited structural material is formed on the front side of the sheet of structural material prior to EDM processing and the EDM processing erodes or cuts through the deposited structural material and sheet structural material; (4) selective regions of deposited structural material are formed on the front side of the sheet of structural material prior to EDM processing and the EDM processing cuts completely through the deposited and sheet structural materials; (5) selective regions of deposited structural material are formed on the front side of the sheet of structural material prior to EDM processing and the EDM processing cuts completely through the sheet structural material but doesn't contact the deposited structural material on the front side and wherein the parts formed include regions of deposited structural material from the front side, sheet structural material, and deposited structural material from the backside; (6) at least one multi-material layer comprised of at least one structural material and at least one sacrificial material is formed on the front side of the sheet of structural material prior to EDM processing and the EDM operations cut through part of the deposited structural material and sacrificial material of the at least one multi-material layer on the front side and the sheet structural material; (7) at least one multi-material layer comprised of at least one structural material and at least one sacrificial material is formed on the front side of the sheet of structural material prior to EDM processing and the EDM processing cuts through only the deposited sacrificial material of the at least one multi-material layer on the front side and the sheet structural material; (8) after the EDM processing that cuts through the sheet of structural material, a sacrificial material is deposited to fill in the eroded regions of the sheet material and thereafter additional structural material is deposited on the front side; (9) a variation of variation 8 wherein the additional structural material is deposited as part of at least one multi-material layer on the front side wherein multi-material layer on the front side includes at least one structural material and at least one sacrificial material; (10) a variation of variation 9 wherein after depositing the additional structural material on the front side, at least one additional EDM operation is performed to cut through at least a portion of the additional deposited material; (11) a variation of variation 9 wherein the depositing of additional structural material only locates structural material in locations intended to become part of the parts; (12) the fabricating of the EDM electrodes comprises an electrochemical deposition process; (13) a variation of variation 12 wherein the electrochemical deposition process for forming EDM electrodes comprises a multi-material deposition process and a planarization process; (14) a variation of variation 13 wherein the electrochemical deposition process is a multi-layer process; (15) a variation of any of variations 12-14 wherein the fabrication of the EDM electrode additionally comprises providing a conformal coating of at least one deposited structural material with a relatively thin coating of dielectric material that is removed from outward facing surfaces and is substantially retained on side facing surfaces of the structural material; (16) a variation of variation 15 wherein the relative thin dielectric coating is less than 5 um thick and more preferably less than 2 um thick and more preferably less than 1 um thick; (17) parts comprise probes for use in a probe card that in turn is used for wafer level testing of semiconductor devices; (18) the parts comprise compliant pins for electrical connectors; (19) a variation of either of variations 17 or 18 wherein the probes or pins comprise a tip material that is different from a material of the body of the probes or pins; (20) a variation of any of variations 17-19 wherein the probes or pins comprise a material in a bonding region that is different from the material of a body of the probes or pins; (21) the parts comprise multi-component devices which are formed in substantially assembled states; (22) prior to removing, the parts are inspected; (23) a variation of variation 22 wherein the parts are that are inspected and have failed the inspection are flagged for special handling; (24) a variation of variation 22 wherein the parts that are flagged for special handling are cut into two or more pieces to enable them to be readily distinguished from structures that did not fail inspection; (25) a variation of variation 22 wherein the parts that are flagged for special handling are attached to adjacent sheet material such that during release, the flagged structures are distinguishable from structures that did not fail inspection; (26) the preparing comprises attaching the multi-material layer on the back side to a frame; (27) a variation of variation 26 wherein the attaching of the multi-material layer to the frame comprises positioning a conductive adhesive material on a surface consisting of (A) a surface of the multi-material layer on the backside and (B) a surface of the frame and then bringing the surfaces of the multi-material layer and the surface of the frame into proximity so as to cause attachment; (28) the preparing comprises attaching the front side of the sheet of structural material, via any overlying material, to a frame; (29) a variation of variation 28 wherein the attaching of the front side of the sheet of structural material to the frame comprises positioning a conductive adhesive on a surface consisting of (A) a surface of the front side of the sheet material or front side of any overlying material, and (B) a surface of the frame and then bringing the surface of the sheet or other material and the surface of the frame into proximity so as to cause attachment; (30) use of an EDM electrode to thin selected portions of the structural that will become portions of the plurality of parts; (31) thinning selected portions of the backside of the sheet of material or structural material forming part of the multi-material layer on the back side such that at least part of the thinned portions become portions of the plurality of parts; (32) a variation of variation 31 wherein the thinning of the backside comprises use of a technique selected from the group consisting of (A) EDM processing, (B) laser machining, and (C) selective etching; (33) a property of the sheet structural material is changed by treatment of the structural material after EDM occurs; (34) the at least one EDM electrode comprises a single electrode array that include a plurality of difference purpose electrodes that are serially stacked including at least two electrodes selected from the group consisting of (A) at least one drilling electrode to form through passages, (B) at least one rough cutting electrode that results in regions that approximate the shape of the parts but does not create part boundaries, and (C) at least one finish electrode that provides for part boundaries; (35) the EDM electrode comprises through passages that allow for dielectric fluid flow and removal of erosion or cutting debris.

Numerous variations of the fourth aspect of the invention are possible and include, for example: (1) the bridging sacrificial material includes a metal; (2) the locating of the bridging material on the sheet of structural material comprises electrodepositing the bridging sacrificial material on the multi-material layer; (3) a complete perimeter of each part is cut through the sheet of structural material by the at least one EDM electrode; (4) a complete perimeter of each part is cut through the sheet of structural material and the at least one multi-material layer by the at least one EDM electrode; (5) at least a portion of the plurality of parts remain tethered to one another or to a structural material frame by tabs of structural sheet material after completion of EDM processing and wherein the tabs are removed after removing the bridging sacrificial material; (6) a layer of a deposited structural material is formed on the front side of the sheet of structural material prior to EDM processing and the EDM processing erodes or cuts through the deposited structural material on the front and the sheet structural material; (7) a layer of a deposited structural material is formed on the front side of the sheet of structural material prior to EDM processing and the EDM processing erodes or cuts through the deposited structural material on the front, the sheet structural material, and the multi-material layer on the back; (8) selective regions of deposited structural material are formed on the front side of the sheet of structural material prior to EDM processing and the EDM processing cuts completely through the deposited structural material on the front and sheet structural material. (9) selective regions of deposited structural material are formed on the front side of the sheet of structural material prior to EDM processing and the EDM processing cuts completely through the deposited structural material on the front, sheet structural material, and the multi-material layer on the back; (10) selective regions of deposited structural material are formed on the front side of the sheet of structural material prior to EDM processing and the EDM processing cuts completely through the sheet structural material but doesn't contact the deposited structural material on the front and wherein the parts formed comprise regions of deposited structural material on the front, sheet structural material, and deposited structural material on the back; (11) at least one multi-material layer including at least one structural material and at least one sacrificial material and is formed on the front side of the sheet of structural material prior to EDM processing and the EDM operations cut through part of the deposited structural material and sacrificial material of the at least one multi-material layer, the sheet structural material, and the multi-material layer on the back; (12) at least one multi-material layer including at least one structural material and at least one sacrificial material is formed on the front side of the sheet of structural material prior to EDM processing and the EDM processing when cutting through at least one of the multi-material layers on the front only cuts through the deposited sacrificial material of the at least one multi-material layer on the front; (13) at least one multi-material layer including at least one structural material and at least one sacrificial material is formed on the front side of the sheet of structural material prior to EDM processing and the EDM processing cuts through only the deposited sacrificial material of the at least one multi-material layer on the front, the sheet structural material, and the multi-material layer on the back; (14) after the EDM processing that cuts through the sheet of structural material, a sacrificial material is deposited to at least partially fill in the eroded regions of the sheet material and thereafter additional structural material is deposited; (15) a variation of variation 14 wherein the additional structural material is deposited as part of at least one multi-material layer that each include at least one structural material and at least one sacrificial material; (16) a variation of variation 15 wherein after deposition of the additional structural material, at least one additional EDM operation is performed to cut through at least a portion of the additional deposited material; (17) a variation of variation 15 wherein the depositing of additional structural material only locates structural material in locations intended to become part of the parts; (18) the fabricating of the EDM electrodes comprises an electrochemical deposition process; (19) a variation of 18 wherein the electrochemical deposition process for forming EDM electrodes comprises a multi-material deposition process and a planarization process; (20) a variation of variation 19 wherein the electrochemical deposition process is a multi-layer process; (21) a variation of any of variations 18-20 wherein the fabrication of the EDM electrode additionally comprises providing a conformal coating of at least one deposited structural material with a relatively thin coating of dielectric material that is removed from outward facing surfaces and is substantially retained on side facing surfaces of the structural material; (22) a variation of variation 21 wherein the relative thin dielectric coating is less than 5 um thick and more preferably less than 2 um thick and more preferably less than 1 um thick; (23) the parts include probes for use in a probe card that in turn is used for wafer level testing of semiconductor devices; (24) the parts comprise compliant pins for electrical connectors; (25) a variation of either variation 23 or 24 wherein the probes or pins comprise a tip material that is different from a material of the body of the probes or pins; (26) a variation of any of variations 22-25 wherein the probes or pins comprise a material in a bonding region that is different from the material of a body of the probes or pins; (27) the parts include multi-component devices which are formed in substantially assembled states; (28) prior to removing, the parts are inspected; (29) a variation of variation 28 wherein the parts that are inspected and have failed the inspection are flagged for special handling; (30) a variation of variation 29 wherein the parts that are flagged for special handling are cut into two or more pieces to enable them to be readily distinguished from structures that did not fail inspection; (31) a variation of variation 29 wherein the parts that are flagged for special handling are attached to adjacent sheet material such that during release, the flagged structures are distinguishable from structures that did not fail inspection; (32) the preparing includes attaching the bridging sacrificial material to a frame; (33) a variation of variation 32 wherein the attaching of the bridging sacrificial material to the frame comprises positioning a conductive adhesive material on a surface consisting of (A) a surface of the bridging sacrificial material and (B) a surface of the frame and then bringing the surfaces of the bridging sacrificial material and the surface of the frame into proximity so as to cause attachment; (34) the preparing includes attaching the front side of the sheet of structural material, via any overlying material to a frame; (35) a variation of variation 34 wherein the attaching of the front side of the sheet of structural material to the frame comprises positioning a conductive adhesive on a surface consisting of (A) a surface of the front side of the structural material or front side of any overlying material, and (B) a surface of the frame and then bringing the surface of the sheet or other material and the surface of the frame into proximity so as to cause attachment; (36) use of an EDM electrode to thin selected portions of the structural material that will become portions of the plurality of parts; (37) a variation of variation 36 additionally including thinning selected portions of the backside of the sheet of material such that at least part of the thinned portions become portions of the plurality of parts; (38) a variation of variation (37) wherein the thinning of the backside includes use of a technique selected from the group consisting of (A) EDM processing, (B) laser machining, and (C) selective etching; (39) a property of the sheet structural material being changed by treatment of the structural material after EDM occurs; (40) the at least one electrode includes a single electrode array that includes a plurality of different purpose electrodes that are serially stacked including at least two electrodes selected from the group consisting of (A) at least one drilling electrode to form through passages, (B) at least one rough cutting electrode that results in regions that approximate the shape of the parts but does not create part boundaries, and (C) at least one finish electrode that provides for part boundaries; (41) the electrode includes through passages that allow for dielectric fluid flow and removal of erosion or cutting debris.

Numerous variations of the thirteenth aspect of the invention are possible and include, for example: (1) the dielectric material covering a majority of the side facing surfaces of the structure, (2) the at least two material includes at least three materials for some layers, (3) the removing is performed by an operation selected from the group consisting of (a) planarizing, (b) filling voids with a rigid filler material, planarizing, and then removing the filler material, and (c) using an anisotropic etching operation such as RIE or DRIE.

Numerous variations of the fourteenth aspect of the invention are possible and include, for example: (1) after removal of the sacrificial material, coating the structural material with a layer of dielectric having a thickness selected from the group consisting of (1) less than 5 um, (2) less than 2 um, (3) less than 1 um, and (4) less than 0.5 um) and (D) removing the dielectric from at least some horizontal surfaces of the structure while leaving the dielectric on most side facing surfaces of the structure.

Other aspects of the invention will be understood by those of skill in the art upon review of the teachings herein. Other aspects of the invention may involve combinations of the above noted aspects of the invention. Other aspects of the invention may involve system and apparatus that can be used in implementing one or more of the above method aspects of the invention. These other aspects of the invention may provide various combinations of the aspects presented above as well as provide other configurations, structures, functional relationships, and processes that have not been specifically set forth above.

### BRIEF DESCRIPTION OF THE DRAWINGS

FIGS. 1A-1D depict perspective views of various states of operation during an example EDM process for forming a structure.

FIG. 2A depicts an example EDM electrode and a workpiece that has been processed by the electrode to form a plurality of parts which at least temporarily remain joined to one another by base material.

FIG. 2B depicts the processed workpiece of FIG. 2A showing some sample dimensions for formed parts.

FIGS. 3A-3C depict perspective views of a workpiece prior to machining (FIG. 3A), an EDM electrode for machining the work piece (FIG. 3B), and the workpiece after machining (FIG. 3C).

FIGS. 4A-1 to 4D depicts sample side cut-views of various stages in a three-cutting step, three-cutting electrode process for EDM machining of a foil or sheet material to produce a desired structure (for simplicity the formation of single structure is shown).

FIGS. 5A-1 to 5D depict various stages in an EDM cutting process that uses a multi-stage electrode to perform drilling, rough cutting, and finish cutting in a single EDM machining operation.

FIGS. 6A-6G depicts side cut views illustrating various process steps during formation of a single stage EDM electrode where side walls of the electrode are coated with a dielectric while the distal facing surfaces of the electrode have exposed conductive surfaces.

FIGS. 7A-7C depict a side cut view of a plurality of example parts to be formed (FIG. 7A) along with two example alternative electrode configurations for machining structures (FIG. 7B and FIG. 7C).

FIGS. 8A and 8B depict a perspective view of two sample probes that may be formed by one of the EDM machining process of the present application.

FIGS. 9A-1 to 9G depicts various states in an alternative fabrication process where a part, or parts, is to be formed from a thick sheet of structural material.

FIG. 10 depicts an example stack of materials that may be processed using an EDM electrode to produce parts from a single sheet of structural material.

FIGS. 11A-11E depicts various states of an example process for preparing a sheet or foil of structural material for EDM processing.

FIGS. 12A and 12B depict the operational parts of two electrodes that will be used in performing EDM on the foil in the example of FIG. 11E with FIG. 12A depicting protruding drill electrodes that will be used in forming through holes in the foil and backing bridge sacrificial material while FIG. 12B depicts the probe electrode that includes recessed probe pin regions that will allow probed shaped structural material to remain after EDM operations are complete.

FIG. 13A depicts the drill electrode over the foil after EDM drilling has occurred leaving through holes in the foil while FIG. 13B depicts a blow up of the drilled hole region.

FIG. 14A depicts the probe electrode over the foil after machining the probe perimeters while FIGS. 14B and 14C depict blown up views of the machined foil.

FIGS. 15A and 15B depict views of a sample electrode bonded to a mandrel that will be used in forming multiple EDM drilled holes.

### DETAILED DESCRIPTION OF PREFERRED EMBODIMENTS

### Electrochemical Fabrication in General

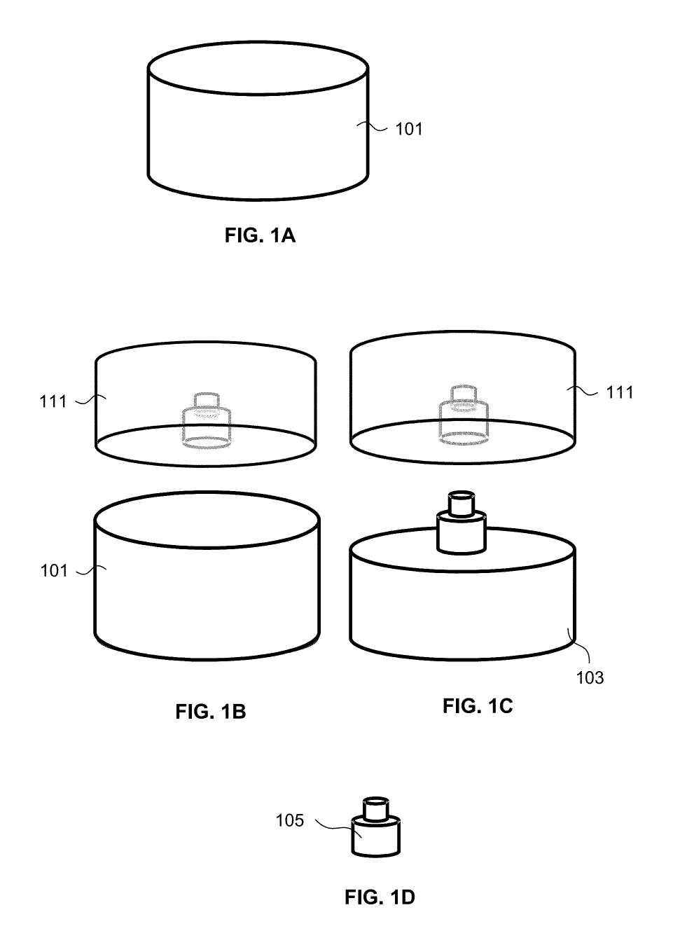

FIGS. 1A-1G, 2A-2F, and 3A-3C of U.S. patent application Ser. No. 14/017,535 (Publication No. 2014-0134453) illustrate various features of one form of electrochemical fabrication. Other electrochemical fabrication techniques are set forth in the '630 patent referenced above, in the various previously incorporated publications, in various other patents and patent applications incorporated herein by reference. Still others may be derived from combinations of various approaches described in these publications, patents, and applications, or are otherwise known or ascertainable by those of skill in the art from the teachings set forth herein. All of these techniques may be combined with those of the various embodiments of various aspects of the invention to yield enhanced embodiments. Still other embodiments may be derived from combinations of the various embodiments explicitly set forth herein.

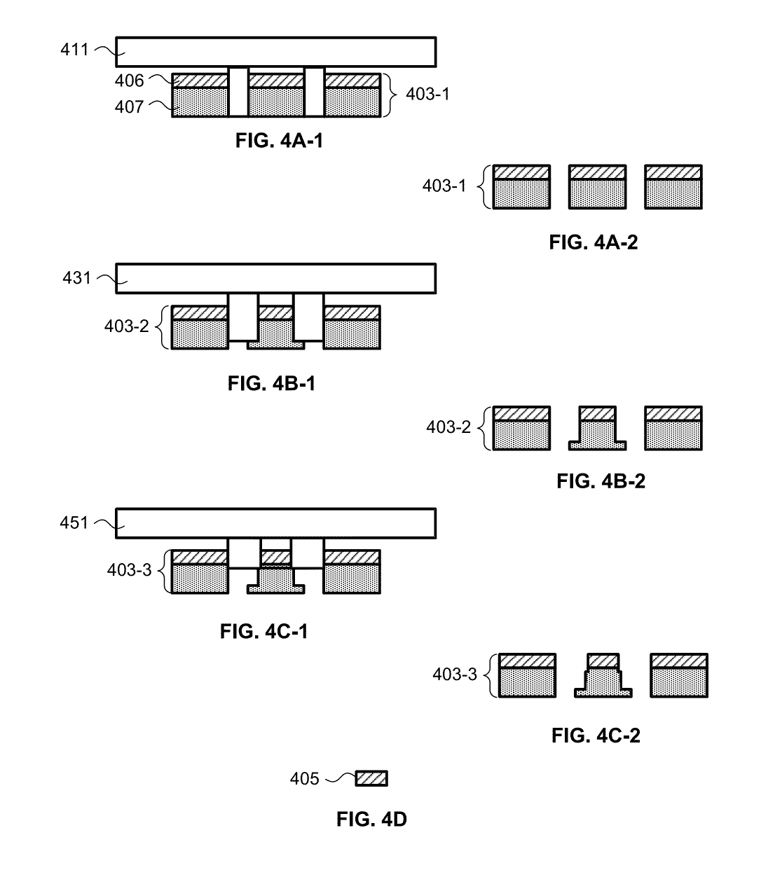

FIGS. 4A-4I of the '535 patent application illustrate various stages in the formation of a single layer of a multi-layer fabrication process where a second metal is deposited on a first metal as well as in openings in the first metal so that the first and second metal form part of the layer. In FIG. 4A a side view of a substrate 82 is shown, onto which patternable photoresist 84 is cast as shown in FIG. 4B. In FIG. 4C, a pattern of resist is shown that results from the curing, exposing, and developing of the resist. The patterning of the photoresist 84 results in openings or apertures 92(a)-92(c) extending from a surface 86 of the photoresist through the thickness of the photoresist to surface 88 of the substrate 82. In FIG. 4D a metal 94 (e.g. nickel) is shown as having been electroplated into the openings 92(a)-92(c). In FIG. 4E the photoresist has been removed (i.e. chemically stripped) from the substrate to expose regions of the substrate 82 which are not covered with the first metal 94. In FIG. 4F a second metal 96 (e.g. silver) is shown as having been blanket electroplated over the entire exposed portions of the substrate 82 (which is conductive) and over the first metal 94 (which is also conductive). FIG. 4G depicts the completed first layer of the structure which has resulted from the planarization of the first and second metals down to a height that exposes the first metal and sets a thickness for the first layer. In FIG. 4H the result of repeating the process steps shown in FIGS. 4B-4G several times to form a multi-layer structure are shown where each layer consists of two materials. For most applications, one of these materials is removed as shown in FIG. 4I to yield a desired 3-D structure 98 (e.g. component or device).

Various embodiments of various aspects of the invention are directed to formation of three-dimensional structures from materials some of which may be supplied in sheet or foil form, electrodeposited or electroless deposited. Some of these structures may be formed form a single build level formed from one or more supplied or deposited materials while others are formed from a plurality of build layers each including at least two materials (e.g. two or more layers, more preferably five or more layers, and most preferably ten or more layers). In some embodiments, layer thicknesses may be as small as one micron or as large as fifty microns. In other embodiments, thinner layers may be used while in other embodiments, thicker layers may be used. In some embodiments structures having features positioned with micron level precision and minimum features size on the order of tens of microns are to be formed. In other embodiments structures with less precise feature placement and/or larger minimum features may be formed. In still other embodiments, higher precision and smaller minimum feature sizes may be desirable. In the present application meso-scale and millimeter scale have the same meaning and refer to devices that may have one or more dimensions extending into the 0.5-20 millimeter range, or somewhat larger and with features positioned with precision in the 1-100 micron range and with minimum features sizes on the order of 10-100 microns.

In some embodiments photoresist or other material may be patterned to aid in the deposit of materials for structures or for making electrodes. Multi-layer structures may be formed using a single patterning technique on all layers or using different patterning techniques on different layers. For example, Various embodiments of the invention may perform selective patterning operations using conformable contact masks and masking operations (i.e. operations that use masks which are contacted to but not adhered to a substrate), proximity masks and masking operations (i.e. operations that use masks that at least partially selectively shield a substrate by their proximity to the substrate even if contact is not made), non-conformable masks and masking operations (i.e. masks and operations based on masks whose contact surfaces are not significantly conformable), and/or adhered masks and masking operations (masks and operations that use masks that are adhered to a substrate onto which selective deposition or etching is to occur as opposed to only being contacted to it). Conformable contact masks, proximity masks, and non-conformable contact masks share the property that they are preformed and brought to, or in proximity to, a surface which is to be treated (i.e. the exposed portions of the surface are to be treated). These masks can generally be removed without damaging the mask or the surface that received treatment to which they were contacted, or located in proximity to. Adhered masks are generally formed on the surface to be treated (i.e. the portion of that surface that is to be masked) and bonded to that surface such that they cannot be separated from that surface without being completely destroyed damaged beyond any point of reuse. Adhered masks may be formed in a number of ways including (1) by application of a photoresist, selective exposure of the photoresist, and then development of the photoresist, (2) selective transfer of pre-patterned masking material, and/or (3) direct formation of masks from computer controlled depositions of material. In some embodiments, structures formed by one of the above methods may be used as EDM electrodes which in turn may be used to pattern other structures from other materials.

Patterning operations may be used in selectively depositing material and/or may be used in the selective etching of material. Selectively etched regions may be selectively filled in or filled in via blanket deposition, or the like, with a different desired material. In some embodiments, the layer-by-layer build up may involve the simultaneous formation of portions of multiple layers. In some embodiments, depositions made in association with some layer levels may result in depositions to regions associated with other layer levels (i.e. regions that lie within the top and bottom boundary levels that define a different layer's geometric configuration).

Temporary substrates on which structures may be formed may be of the sacrificial-type (i.e. destroyed or damaged during separation of deposited materials to the extent they can not be reused), non-sacrificial-type (i.e. not destroyed or excessively damaged, i.e. not damaged to the extent they may not be reused, e.g. with a sacrificial or release layer located between the substrate and the initial layers of a structure that is formed). Non-sacrificial substrates may be considered reusable, with little or no rework (e.g. replanarizing one or more selected surfaces or applying a release layer, and the like) though they may or may not be reused for a variety of reasons.

The '535 application also provides a number of embodiments that may be combined with the EDM methods of the presentation to provide enhanced embodiments. The definition of terms set forth in the '535 application, to the extent needed, may be used to aid in understanding the teachings herein.

Laser Cutting to Produce Microstructure Alone or in Combination with Electrochemical Fabrication Methods:

Various Methods for using laser machining alone or in combination with electrochemical fabrication methods to produce micro-scale or millimeter-scale probes and other parts are taught in U.S. patent application Ser. No. 14/156,437, filed Jan. 15, 2014. Many results of the laser cutting methods set forth in this referenced application are similar to those of EDM cutting methods and as such the various methods described in this referenced application, the various alternatives steps, and various material combinations are directly applicable useful in conjunction with EDM processing. The teachings of this referenced application are incorporated herein by reference as if set forth in full herein.

Electro Discharge Machining to Produce Microprobes and Other Micro-Scale or Millimeter Scale Parts:

Embodiments of the present invention use electro discharge machining to simultaneously form multiple three-dimensional parts (e.g. 10 s, 100 s, 1,000 s, or even 10,000 s) with millimeter scale or micron-scale features and micron scale tolerances from foils or sheets of material. Some embodiments of the present invention use a single or multi-layer multi-material electrochemical manufacturing processes (such as Microfabrica's Mica Freeform® processes) to form sinker-EDM electrodes which are used to cut outlines of parts from a foil or sheet material while it is joined to a backing sacrificial bridge material. In some alternative embodiments, instead of using a sacrificial bridge material, a thicker volume of structural material is used which has its backside machined down after performance of EDM operations to separate the plurality of parts. Some embodiments use more complex arrangements of: (1) multiple attached sheets of material, (2) one or more attached deposits of single material layers, (3) one or more attached deposits of multi-material layers that undergo EDM machining with or without a separate bridging sacrificial material. Some embodiments may use a sheet of structural material that has been modified to include regions of a second structural material (e.g. by selective etching, laser machining, initial EDM processing to form openings into which a second structural material or third structural material may be deposited) which can be machined together to form a desired structure. In some embodiments, EDM operations may be performed on a part of the structural materials after which additional structural materials and perhaps sacrificial materials added and then further EDM operations made to occur.

In some embodiments system components may include: (1) a precision EDM machine including an appropriate positioning and alignment components, power supply or power supplies, fluid containers for holding dielectric fluids, flow configuration channels, tubing, jets, etc., (2) EDM electrodes, e.g. fabricated by multi-layer or single layer, multi-material electrochemical fabrication processes, (3) tooling to attach the electrodes to the EDM machine, (4) tooling for holding the workpiece within the machine, (5) alignment means (e.g. pins and holes, optical elements and detection systems, such as microscopes and visions systems, or the like) for ensuring proper alignment between the electrodes and workpieces. In some embodiments, electrodes may be formed with fluid flow passages for the pumping dielectric into a working region and the removal of debris from the working region. Such passages could obviate or reduce a need for other passages such as those formed by an initial drilling operation.

In some embodiments process steps include: (1) fabricating electrode(s) via a standard multi-layer, multi-material electrochemical fabrication process with some modifications. e.g. one or more steps to provide for a dielectric coating on electrode sidewall surfaces; (2) mounting the electrode to adapter which mechanically holds the electrode in EDM machine and allows for electrical contact to machine power supply. Steps for fabricating the workpiece may include (1) Plating sacrificial bridging material on one side of structural material sheet or foil, (2) mounting the plated sheet to a rigid structure, (3) mounting the plate sheet/structure combination within machine, allowing for electrical contact to machine power supply, (4) machining out material from the sheet to form boundary regions of the parts without completely cutting through the sacrificial bridging material along the perimeters of parts (some cutting through of the sacrificial material may be acceptable and even desirable, e.g. drilled holes for debris removal). EDM operations may be performed in a single finish cut or may involve multiple operations to provide better results, e.g. drilling of holes through both the foil and bridging material to allow flow of dielectric and removal of avoid debris, one or more rough cutting operations to remove the bulk of the material, one or more finish cutting operations to remove final volumes of material and provide boundaries for the parts.

FIGS. 1A-1D depict perspective views of various states of operation during an example EDM process for forming a structure.

FIG. 1A provides a perspective view of a workpiece 101 (e.g. a sheet of material or part of a sheet of material) from which a structure, multi-element device (i.e. part), multiple structures, or multiple parts can be formed.

FIG. 1B depicts the state of the process prior to an electrode 111 being bought into contact with the workpiece 101 of FIG. 1A.

FIG. 1C depicts the state of the process after the electrode 111 is brought into proximity to the workpiece 101 and EDM machining has occurred and thereafter the electrode and processed workpiece 103 are separated.

FIG. 1D depicts the state of the process after the processed workpiece 105 has been further processed to remove a base portion such that only the desired part remains.

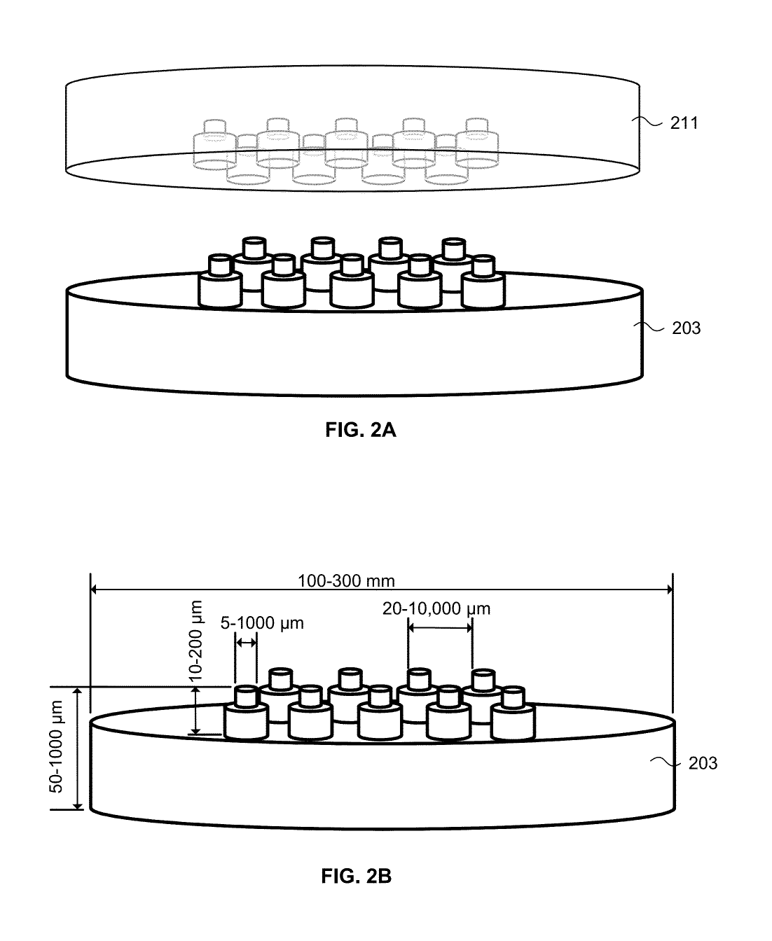

FIG. 2A depicts an example EDM electrode 211 and a workpiece 203 that has been processed by the electrode to form a plurality of parts which at least temporarily remain joined to one another by base material.

FIG. 2B depicts the processed workpiece 203 of FIG. 2A showing some sample dimensions for formed parts.

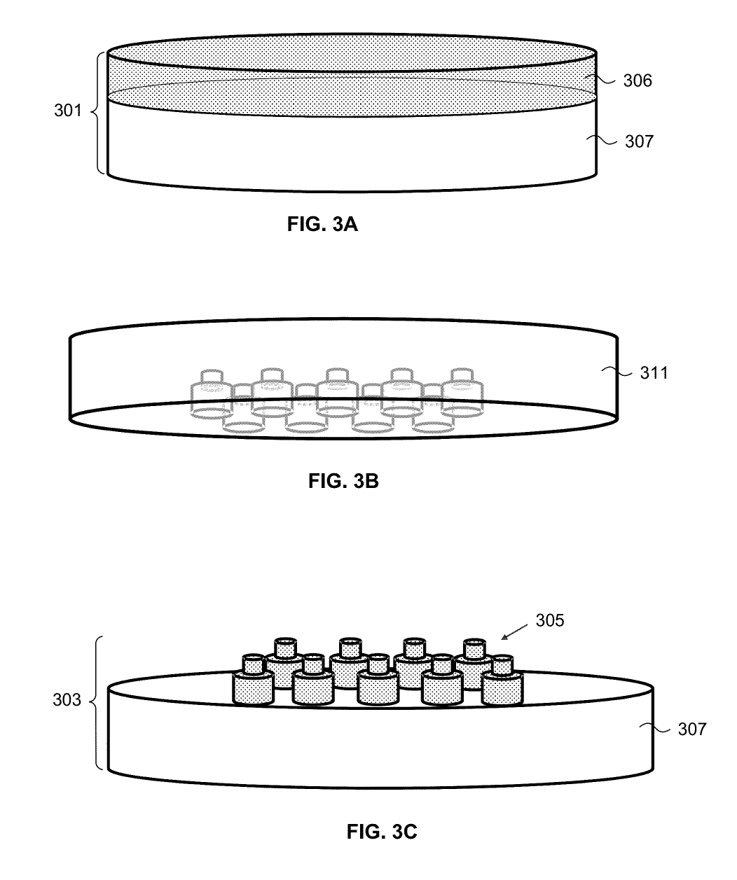

FIGS. 3A-3C depict perspective views of a workpiece 301 prior to machining, an EDM electrode 311 for machining the work piece, and the workpiece 303 after machining.

FIG. 3A depicts a perspective view of a workpiece 301 formed from a structural material 306 (perhaps a deposited material or sheet material) which is joined to a bridging sacrificial material 307. For example, it may have been deposited on the structural material (e.g. it may be a metal deposited via electrodeposition or electroless deposition) according to an embodiment of the invention. Alternatively the structural material may have been deposited on it.

FIG. 3B depicts a partially transparent perspective view of an EDM electrode 311 that may be used to make a plurality of parts from the structural material of the workpiece.

FIG. 3C depicts a perspective view of the processed workpiece 303 of FIG. 3A wherein the only structural material remaining forms the plurality of desired parts 305 which are still temporarily held to one another by the sacrificial material 307 which may or may have under gone some amount of machining.

FIGS. 4A-1 to 4D depicts sample side cut-views of various stages in a three electrode, three-cutting step process for EDM machining a foil or sheet material to produce a desired structure. For simplicity the formation of single structure is shown.

FIG. 4A-1 depicts a drilling operation with an EDM electrode 411 having a plurality of small diameter cutting electrodes penetrating completely through a workpiece 403-1 formed of a structural foil or sheet 406 (e.g. tungsten, molybdenum, or the like) and a bridging sacrificial material 407 (e.g. copper, tin, or the like) which results in drilling of holes through the workpiece that may act as debris removal paths or otherwise improve flow of dielectric during the cutting process. The holes formed by the drilling electrodes maybe circular, square, oval, rectangular, etc. The holes formed by drilling may be formed from only material contacted by the electrode or they may be formed by removal of central material after the electrode cuts away a complete perimeter of material. It is not intended that the drilling electrodes completely remove material from around the perimeter(s) of the part(s) being formed but instead to form perforations in these perimeter regions. The drilling electrodes are sized and positioned so that they are offset from the boundaries that will actually form perimeters of the part(s).

FIG. 4A-2 depicts the workpiece 403-1 after removal of the electrode of FIG. 4A-1.

FIG. 4B-1 depicts a rough cutting operation with an EDM electrode 431 having one or more larger diameter electrodes relative to a diameter of the drilling electrodes. The purpose of the rough cutting electrode(s) is to remove the bulk of the structural material that is to be removed from around the perimeter(s) of the part(s) being formed while not cutting completely through the workpiece 403-2 and while not actually forming the boundaries of the part(s). After rough cutting the rough shape of the part is, or parts are, formed while still retaining a perforated connection between the parts via the bridging material.

FIG. 4B-2 depicts the workpiece 403-2 after rough cutting is completed.

FIG. 4C-1 depicts a finish cutting operation where an EDM electrode 451 with one or more cutting electrodes sized and positioned to define the perimeters of the part, or parts, has cut to a desired depth in work piece 403-3. Like in rough cutting, the finishing electrodes do not cut completely through the bridging material but they do cut completely through the structural material. As a result of finish cutting, the part or parts are formed with desired cut configurations while still retaining a bridged relationship with the sheet as a whole and with any other parts formed.

FIG. 4C-2 depicts the workpiece 403-3 after finish cutting is complete.

FIG. 4D depicts a separated part 405 after the bridging sacrificial material has been removed (e.g. by etching). In typical processes multiple parts would be formed in batch and released in batch. In some variations, parts, or groups of parts, would remain tethered, at least temporarily, to one another or to a handle structure, via either remaining sacrificial bridging material of the same type, or of different type, compared to the bridging sacrificial material that was removed or via small tabs of structural material that can be removed subsequently by laser cutting or the like.

FIGS. 5A-1 to 5D depict various states in an EDM cutting process that uses a multi-stage electrode to perform drilling, rough cutting, and finish cutting in a single EDM machining operation. The Electrode 511 includes a base region that supports finish cutting electrode elements 511-1, which in turn support rough cutting electrode elements 511-2, which in turn support drilling electrodes 511-3. As cutting progressively occurs, the resulting machining transitions from drilling, to rough cutting, to finish cutting.

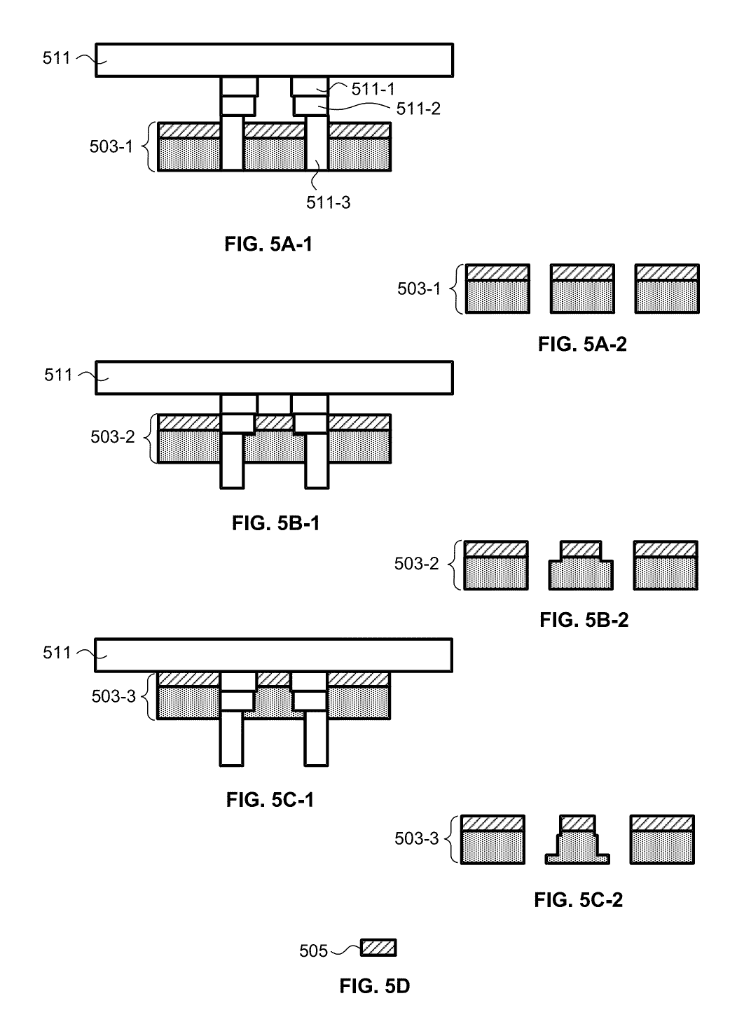

FIG. 5A-1 depicts the state of the process after the drilling electrodes 511-3 have completely penetrated both the structural material and bridging sacrificial material of the workpiece 503-1 but where rough cutting has yet to begin.

FIG. 5A-2 depicts the workpiece 503-1 (without the multi-stage electrode present) with the degree of cutting equivalent to that of FIG. 5A-1.

FIG. 5B-1 depicts the state of the process after the rough cutting electrode(s) 511-2 have completely cut through the structural material of the workpiece 503-2 but where finish cutting has yet to begin.

FIG. 5B-2 depicts the workpiece 503-2 (without the multi-stage electrode present) with the degree of cutting equivalent to that of FIG. 5B-1.

FIG. 5C-1 depicts the state of the process after the finish cutting electrode(s) 511-1 have completely cut through the structural material of the workpiece 503-3 and the rough cutting electrode have cut in to the bridging sacrificial material but not all the way through it.

FIG. 5C-2 depicts the workpiece 503-3 (without the multi-stage electrode present) with the degree of cutting equivalent to that of FIG. 5C-1.

FIG. 5D depicts the resulting part 505 after removal of the bridging sacrificial material.

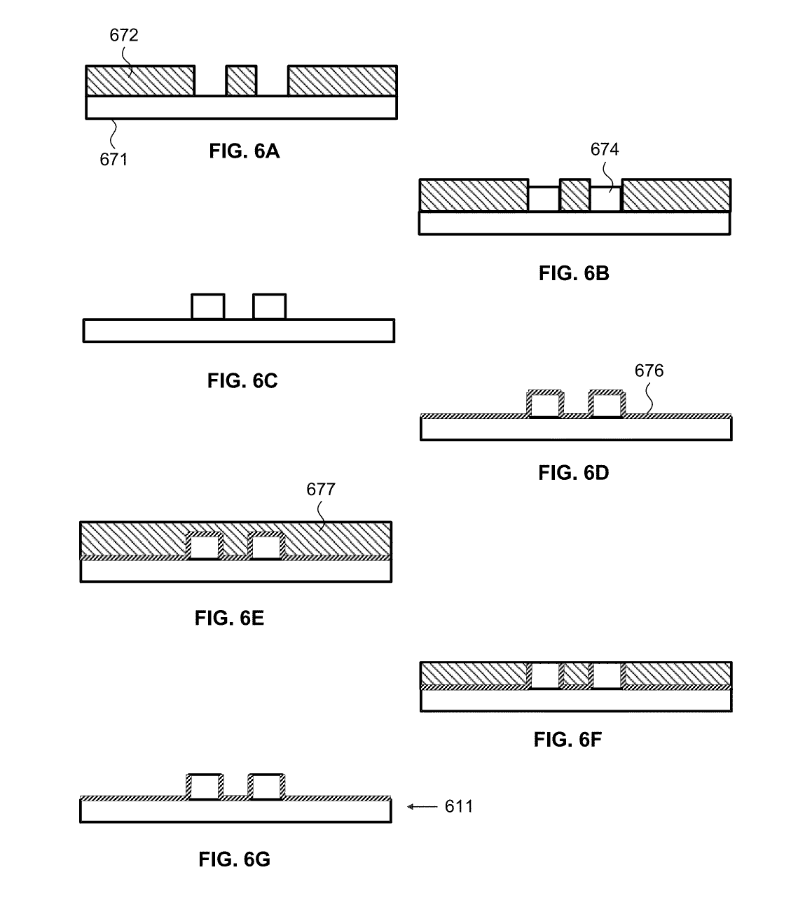

FIGS. 6A-6G depict side cut views illustrating various process steps during formation of a single stage EDM electrode where side walls of the electrode are coated with a dielectric while the distal facing surfaces of the electrode have exposed conductive surfaces.

FIG. 6A depicts a substrate 671 on which a photoresist 672 has been patterned. Patterning of the photoresist may occur in a number of different ways including lithographically or by laser ablation.

FIG. 6B depicts the state of the process where a conductive electrode material 674 is deposited into the voids in the photoresist (e.g. a nickel alloy, copper, or any other appropriate EDM electrode material).

FIG. 6C depicts the state of the process after the photoresist is stripped leaving cutting electrodes protruding from the substrate.

FIG. 6D depicts the state of the process after a dielectric material 676 is deposited onto the substrate and cutting electrodes. The deposition of the dielectric may occur in a number of different ways including CVD, PVD (cathodic arc deposition, electron beam PVD, evaporative deposition, pulse laser deposition, sputtering, or the like). Alternatively, the surface of the electrode may be treated or modified to make it non-conductive.

FIG. 6E depicts the state of the process after the coated electrode(s) and substrate are blanket coated with a support material 677 that can act as a temporary support to allow planarization. The support material may take a number of different forms. For example it may be a photoresist, a metal (e.g. copper) that can be subsequently separated from the electrode material (e.g. nickel cobalt), and dielectric materials without damaging them.

FIG. 6F depicts the state of the process after the support material, the electrode material and the dielectric are planarized to remove the dielectric from the distal end of the electrode material and to set a desired height for the electrode material.

FIG. 6G depicts the state of the process after remaining support material is removed.

In an alternative process for forming multi-level electrodes with sidewall dielectric coatings, the electrodes may be formed according to a multi-material, multi-layer electrochemical fabrication process with the sacrificial material removed after which a dielectric coating may be sputtered or otherwise applied and then the coating may be removed from the horizontal surfaces by some form of anisotropic etching, such as RIE, while leaving the coating on the vertical walls.

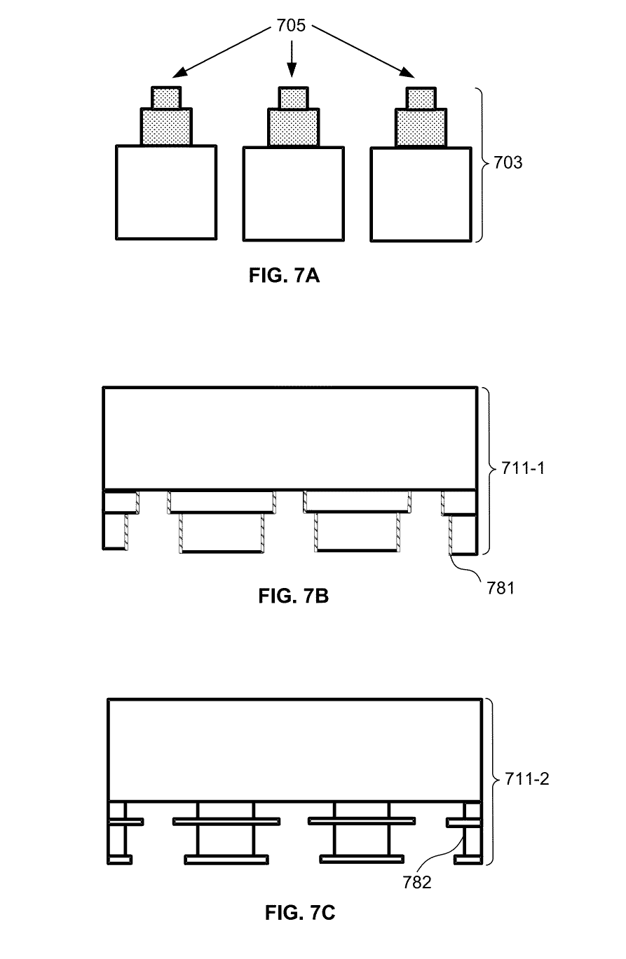

FIGS. 7A-7C depict a side cut view of a plurality of example parts to be formed along with two example alternative electrode configurations for machining structures.

FIG. 7A depicts a workpiece 703 with pre-drilled through holes and with a plurality of parts 705 sitting of a substrate wherein the parts have two distinct formation levels.

FIG. 7B depicts an EDM electrode 711-1 that can be used to fabricate the parts of FIG. 7A. The electrode of FIG. 7B may be formed using the alternative process discussed above for forming electrodes with vertical surfaces coated with a dielectric 781.

FIG. 7C depicts an alternative electrode 711-2 for forming the parts of FIG. 7A wherein the vertical side walls 782 of the electrodes are formed in such a way that they are recessed from the horizontal extremes of the electrodes. Such electrodes may be formed using a multi-material, multi-layer electrochemical fabrication process as discussed in a number of the patents and published applications that have been incorporated by reference.

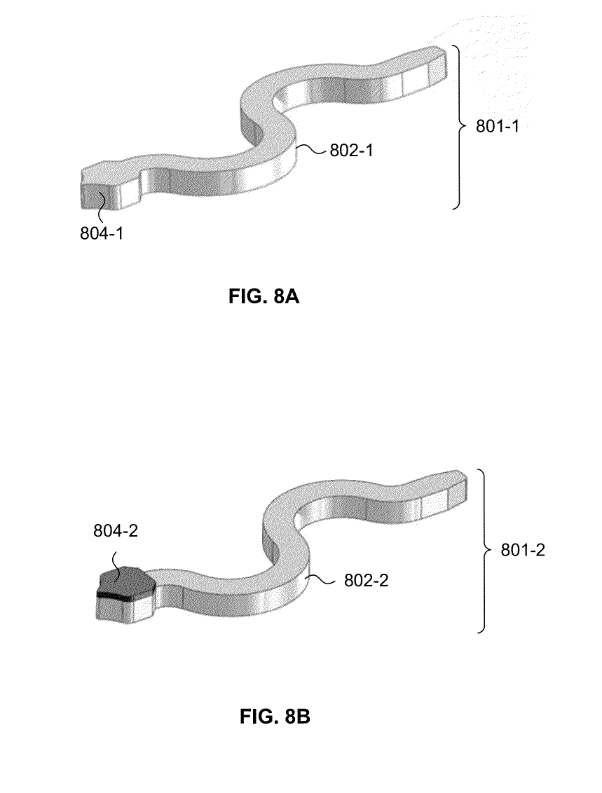

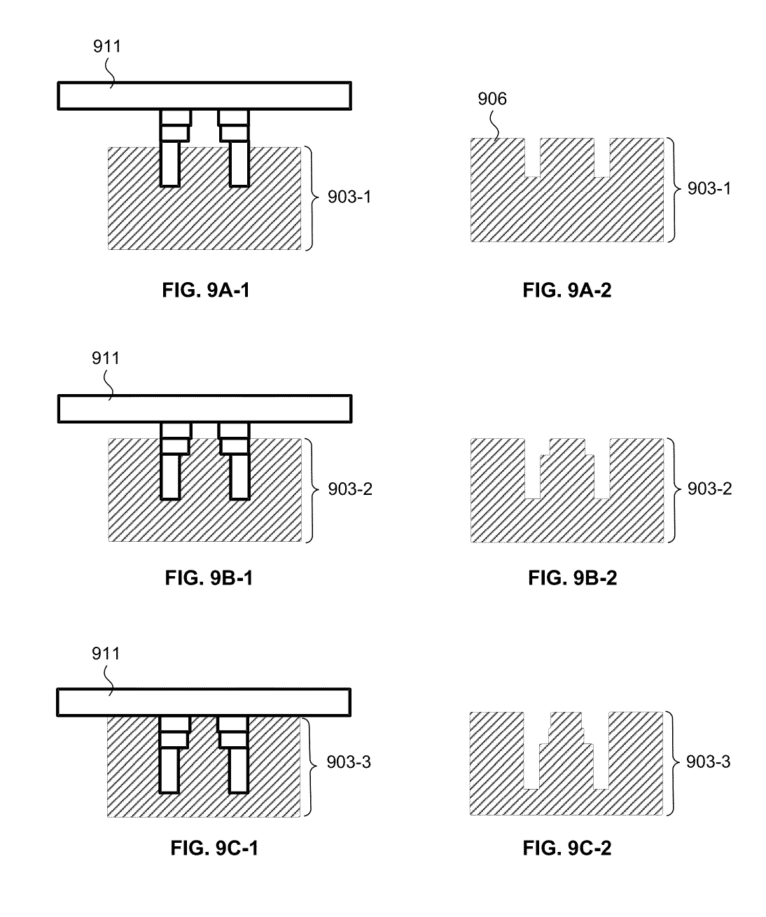

FIGS. 8A and 8B depict a perspective view of two sample probes that may be formed by one of the EDM machining process of the present application.

FIG. 8A shows a planar probe 801-1 which can be cut from a single sheet of structural material using an appropriately shaped EDM electrode (more preferably a plurality of electrodes would be used to form a plurality of parts in parallel, i.e. in batch). The probe has a body portion 802-1 and a tip portion 804-1 both formed from sheet material.

FIG. 8B shows a similar probe 801-2 to that of FIG. 8A with the exception that it additionally includes a tip material 804-2 located on one surface of the sheet material forming the body 802-2 and part of the tip region of the probe. Formation of such a probe can occur in a variety of ways: (1) regions of tip material can be plated onto the sheet material, perhaps with aid of an adhesion layer and seed layer, and then EDM machining may shape the tip material and the probe body material in the same operation(s); (2) patterned regions of tip material may be deposited according to their desired configuration in a multi-layer or single layer multi-material electrochemical fabrication process and then EDM machining may be able to cut through the sheet material but not the tip material and then after removal of any surrounding bridging or other sacrificial material the probes with their respective tips can be separated. During EDM cutting from above, any deposited tip material may be located on the underside of the sheet such that it may not be cut through or only partially cut through. Alternatively it may be located on the upper side of the sheet material where it may be cut through depending on electrode location and tip material location.

FIGS. 9A-1 to 9G depicts various states in an alternative fabrication process where the part or parts are to be formed from a thick sheet of structural material using a three-stage electrode.

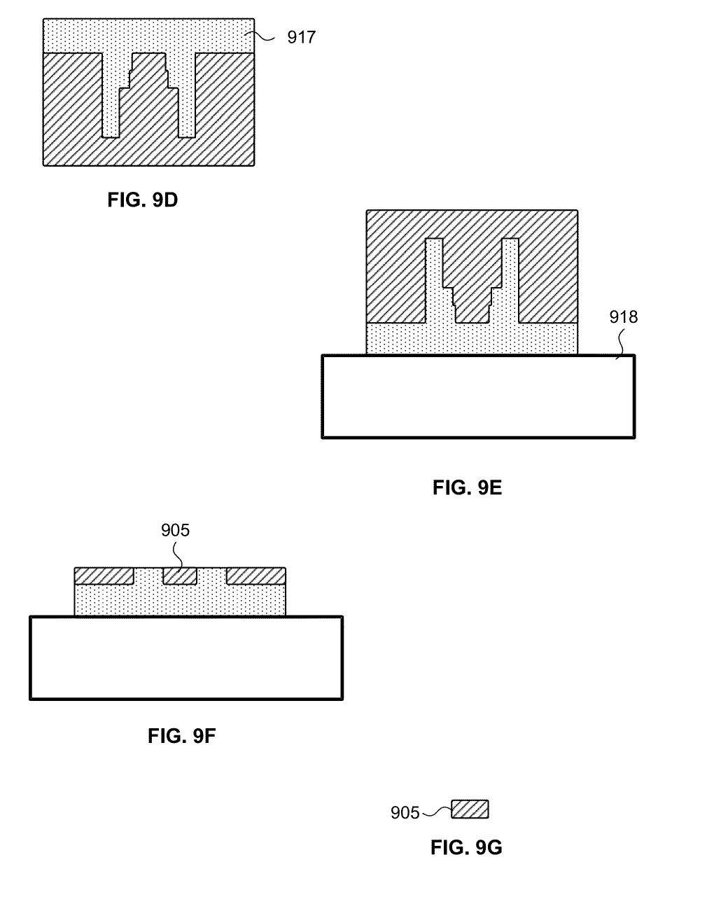

FIG. 9A-1 depicts the state of the process after the drill portion of a multi-stage electrode 911 cuts into the structural material to yield a workpiece 903-1 with blind holes while FIG. 9A-2 depicts the resulting workpiece (i.e. structural material) 903-1 with the electrode removed. In actual operation with this electrode, it may or may not be removed prior to cutting each of the three levels.

FIG. 9B-1 depicts the state of the process after the drill portion penetrates deeper into the structural material and the rough cut section also cuts the structural material to yield workpiece 903-2 while FIG. 9B-2 depicts the resulting workpiece 903-2 as it would look with the electrode removed.

FIG. 9C-1 depicts the state of the process after the drill portion penetrates deeper into the structural material, the rough cut section also cuts deeper into the structural material, and the finish section cuts the material such that workpiece 903-3 results while FIG. 9C-2 depicts the resulting structural material as it would look with the electrode removed.

FIG. 9D depicts the state of the process after a sacrificial material 917 is made to fill the voids in the structural material. In some embodiments the sacrificial material could be electroplated copper, spun on photoresist, or any other material that provides stabilization for subsequent operations and thereafter removed from the structural material.

FIG. 9E depicts the state of the process after the sacrificial material is attached to a substrate 918 to allow further processing. Attachment to the substrate may occur in a variety of ways including use of a pressure sensitive adhesive, a meltable and resolidifiable material, or the like. In some embodiments, it may not be necessary to use a substrate at all but to hold the workpiece with a vacuum chuck, other tool, or the like.

FIG. 9F depicts the state of the process after the bulk of the structural material is planarized so that a part 905 of desired thickness remains.

FIG. 9G depicts the state of the process after the sacrificial material, substrate, and extraneous structural material are removed leaving only the part 905.

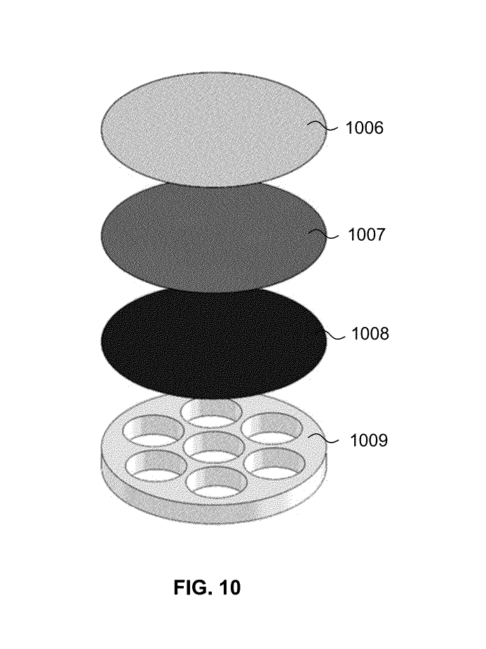

FIG. 10 depicts an example stack of materials that may be processed using an EDM electrode to produce parts from a single sheet of structural material. The material stack includes, for example, a sheet of structural material 1006, a bridging sacrificial material 1007 (e.g. a metal deposited onto the structural material, an adhesive 1008, and a stiffening substrate 1009.

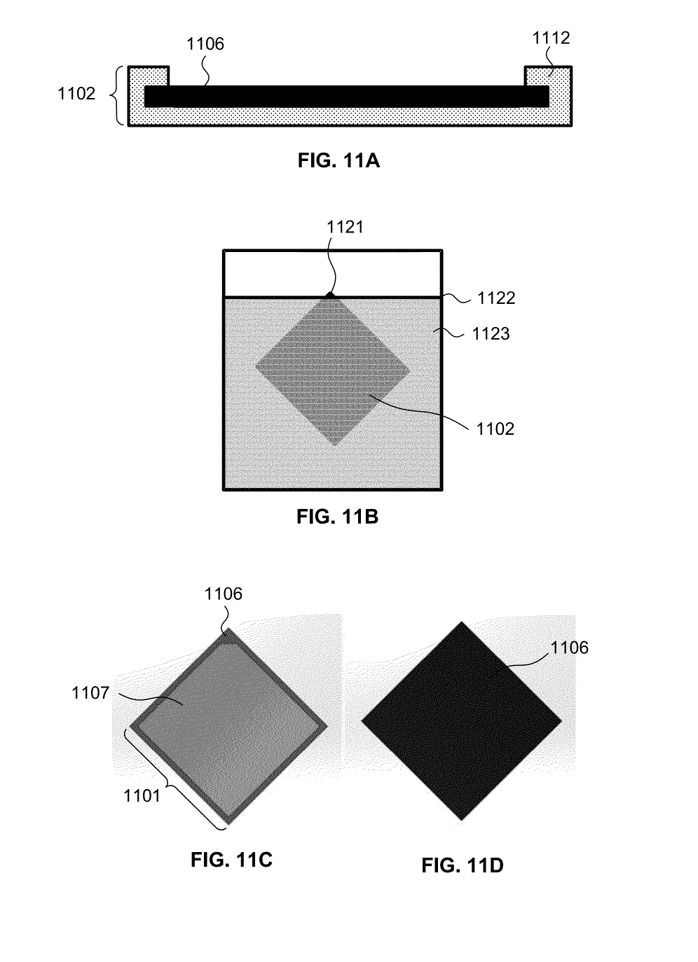

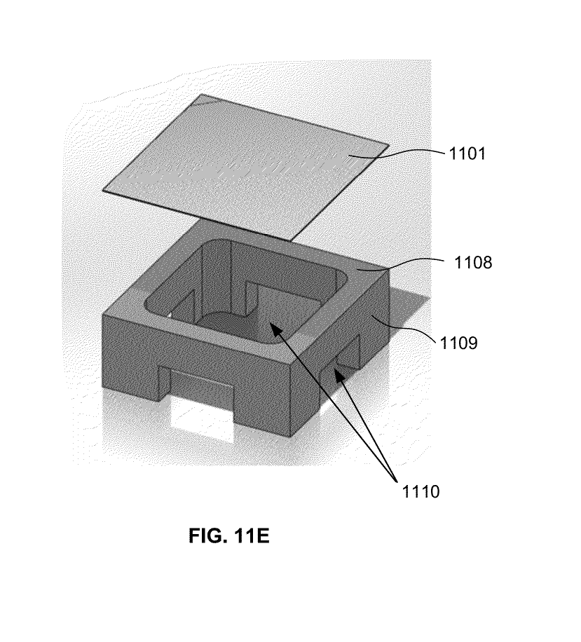

FIGS. 11A-11E depicts various states of an example process for preparing a sheet or foil of structural material for EDM processing.

FIG. 11A depicts a side cut view of a combined element 1102 including a foil or sheet of structural material 1106 coated with a photoresist 1112 to protect part of it from being electroplated.

FIG. 11B depicts a schematic, side cut view of the combined element 1102 of FIG. 11A immersed in an electroplating tank in preparation for plating the exposed surface of the structural material with a sacrificial bridging material (e.g. copper). As shown a corner or electrical contact location 1121 on the element 1102 remains above an upper surface level 1122 of the electroplating bath 1123.

FIGS. 11C and 11D depict the copper 1107 coated side and the uncoated side structural material 1106 side, respectively, of the plated foil 1101 after the plating of copper and removal of photoresist.

FIG. 11E depicts the copper coated foil 1101 being bonded to a stiffening substrate or frame 1109 via an epoxy 1108 in preparation for performing EDM cutting wherein the substrate provides a rigid frame but an open center with flow paths 1110 to allow dielectric fluid and debris to be moved during cutting.

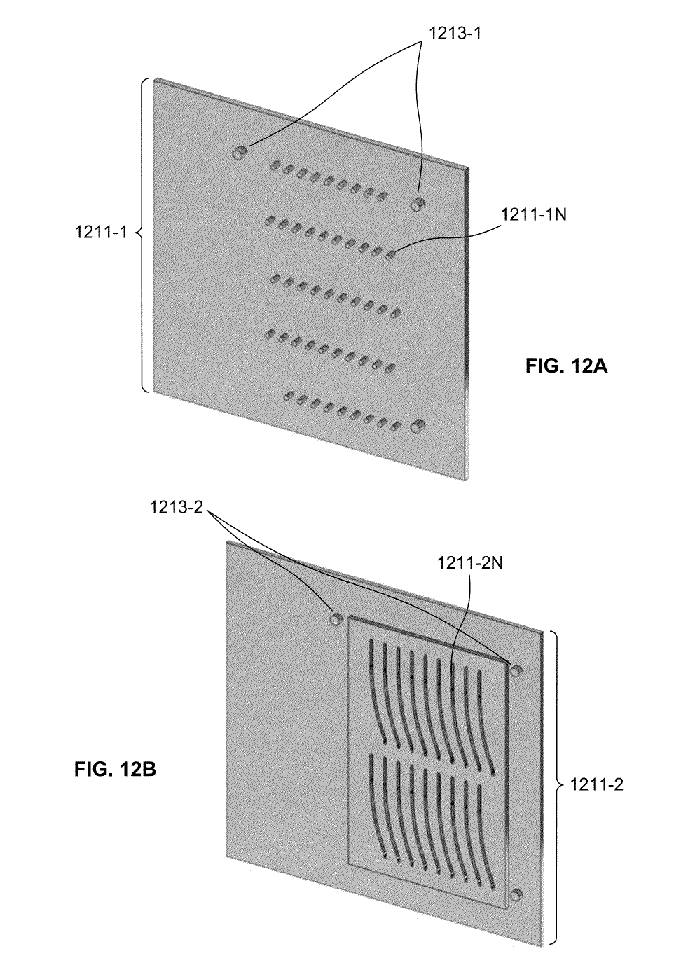

FIGS. 12A and 12B depict the operational parts of two electrodes 1211-1 and 1211-2 that may be used in performing EDM patterning on the foil in forming the parts using the supported sheet of FIG. 11E. FIG. 12A depicts a drill electrode having protruding drill electrodes 1211-1N that will be used in forming through holes in the foil and backing bridge sacrificial material along with alignment pins 1213-1 while FIG. 12B depicts a probe electrode 1211-2 that includes recessed probe pin regions 1211-2N that will allow probed shaped structural material to remain after EDM operations are complete. FIG. 12B also shows alignment pin elements 1213-2 that can be used in ensuring alignment between the patterns cut by the drill electrode and those cut by the probe electrode.

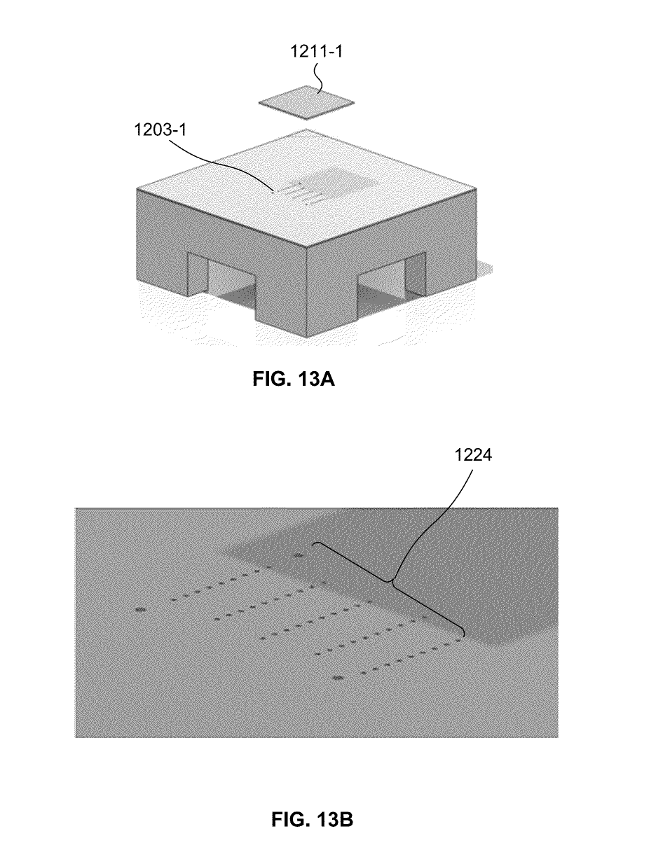

FIG. 13A depicts the drill electrode 1211-1 over the foil 1203-1 after EDM drilling has occurred leaving through holes in the foil while FIG. 13B depicts a blow up of the drilled hole region 1224 corresponding to the pattern of electrode 1211-1.

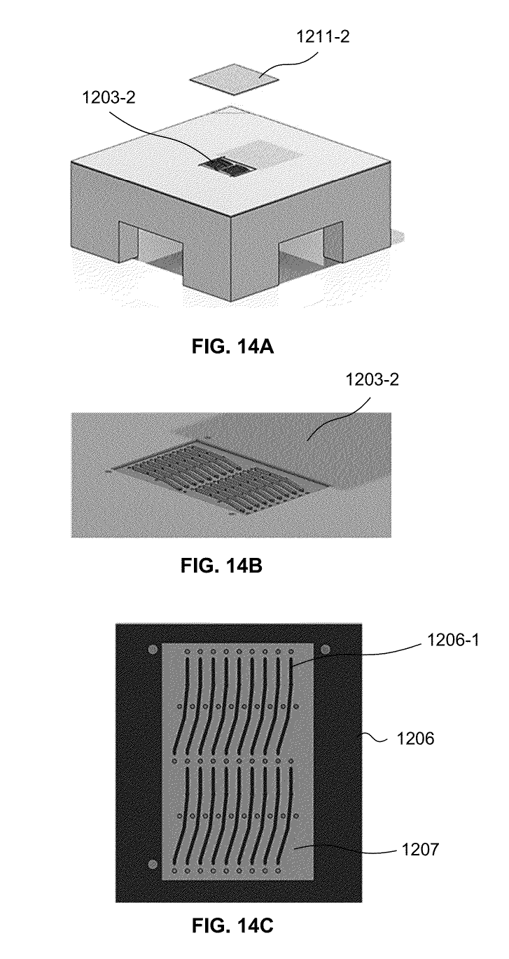

FIG. 14A depicts the probe electrode 1211-2 over the foil 1203-2 after machining the probe perimeters while FIGS. 14B and 14C depict blown up views of the machined foil showing probe structure regions 1206-1 patterned from structural material 1206 and surrounded by exposed sacrificial material 1207.

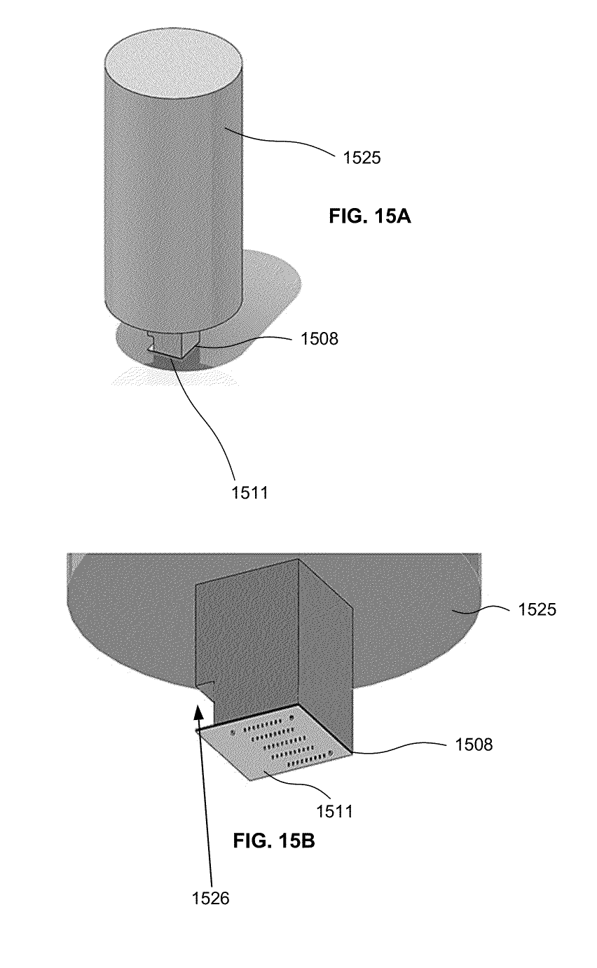

FIGS. 15A and 15B depict views of a sample electrode 1511 bonded to a mandrel 1525 via an adhesive bonding material 1508 that will be used in forming multiple EDM drilled holes wherein a relief region is located behind a portion of the electrode to allow electrical contact to be made, for example via a soldered wire or a fold electrode attached from the side. In some alternative embodiments, if needed, electrodes may be divided into different regions that are separated by dielectrics with individual electrical contacts made and power control systems used to achieve more uniform or faster cutting from an EDM electrode array as a whole.

The application of EDM processes for shaping of probes and other micro-scale and millimeter-scale parts can occur in a variety of ways, some of which have been described in some detail above and others which are outlined hereafter.

Group 1 Methods:

In a first group of embodiments a plurality of parts may be produced by using a single sheet of structural material with a layer of bridging sacrificial material on its backside, with EDM occurring from the front side to cut out part outlines while leaving the individual parts still joined by the bridging material.

Example pre-EDM operations may involve one or more of: (1) the bridging material being deposited onto the sheet by electroplating, (2) the bridging material being deposited onto the sheet by electroless deposition, or (3) the bridging material being a sheet of conductive material that is adhered to the sheet of structural material by (a) ultrasonic bonding, (b) diffusion bonding, (c) use of an intermediate low melting temperature material in combination with heating and cooling, or (d) an adhesive (epoxy, pressure sensitive, thermoset, anaerobic, etc.) and appropriate initiation for bonding. Planarization operations may be used to ensure desired layer thicknesses or uniformities.

Example EDM Operations may involve one or more of: (1) Use of one or more EDM electrodes which may take the form of drilling electrodes, rough cutting electrodes, finish electrodes, etc., (2) Use of EDM electrodes that are formed by single layer or multi-layer electrochemical fabrication steps, (3) Use of single electrodes that have more than one stage so that progressive insertion performs different types of cutting such as drilling, rough cutting, finish cutting, etc.

Example after EDM operations may involve one or more of: (1) Release of the formed parts by removal of the bridging material by etching, dissolving an adhesive, peeling, etc. (2) Prior to release of formed parts from the bridging material, adding additional structural materials selectively or in a blanket manner with subsequent patterning occurring by (a) laser cutting, (b) etching, (c) further EDM operations, and the like. Some of the added structural material may be in the form of one or more multi-material electrochemically deposited layers. In some embodiments, prior to addition of further structural materials, additional sacrificial material may be added to fill in cut lines resulting from the EDM operations. These added structural materials may provide for formation of enhanced parts made from both the sheet material and one or more patterned regions of deposited structural material (e.g. the added structural material may provide for tips made from a distinct tip material and bonding regions made from a distinct bonding material. Planarization operations may be used to set layer levels or as intermediate processing steps as necessary.

Group 2 Methods:

In a second group of embodiments a plurality of parts may be produced by processing a sheet of structural material with at least one multi-material layer formed on the backside of the sheet of structural material with EDM occurring from the front side to cut out part outlines while leaving the individual parts still joined by material forming at least a lowest one of the multi-material layers or an optional bridging sacrificial material formed on the lowest of the multi-material layers.

Example Pre-EDM Operations may involve: (1) a single multi-material layer being formed on the backside of the sheet with patterning of structural material in the multi-material layer defining desired patterns of structural material such that during EDM operations, the structural material of the multi-material layer is not cut while sacrificial material of the multi-material layer acts as a bridging material; (2) a single multi-material layer being formed on the backside of the sheet with patterning of structural material in the multi-material layer defining most of the desired patterns of structural material such that during EDM operations only relative small regions of the structural material of the multi-material layer are cut completely through leaving the sacrificial material of the multi-material layer to act an effective bridging material; (3) at least one multi-material layer being formed on the backside of the sheet and a layer of sacrificial bridging material being formed below it or them wherein the EDM operations cut through the sheet and at least one of the multi-material layers such that desired structures are formed and the sacrificial bridging material and possibly some of the sacrificial material of the one or more multi-material layers acts as a bridging material. In these variations the bridging material may, for example, be (a) deposited by electroplating, (b) deposited by electroless plating, (c) a sheet of conductive material that is adhered to the sheet of structural material by (1) ultrasonic bonding, (2) diffusion bonding, (3) use of an intermediate low melting temperature material in combination with heating and cooling, or (4) an adhesive (pressure sensitive, thermoset, anaerobic, etc.) and appropriate initiation for bonding. Planarization operations may be used to ensure desired layer thicknesses or uniformities.

Example EDM operations may involve: (1) Using one or more EDM electrodes which may take the form of drilling electrodes, rough cutting electrodes, finish electrodes, etc., (2) Using EDM electrodes formed by single layer or multi-layer electrochemical fabrication steps, (3) Using single electrodes that have more than one stage so that progressive insertion performs different types of cutting such as drilling, rough cutting, finish cutting, etc.

Example after EDM operations may involve: (1) Releasing of the formed parts by removal of the bridging material by etching, dissolving an adhesive, peeling, etc. (2) Prior to release of formed parts from the bridging material, adding additional structural materials, selectively or in a blanket manner, with subsequent patterning occurring by (a) laser cutting, (b) etching, (c) further EDM operations, and the like. Some of the added structural material may be in the form of one or more multi-material electrochemically deposited layers. In some embodiments, prior to addition of further structural materials, additional sacrificial material may be added to fill cut lines or areas that resulted from the EDM operations. These added structural materials may provide for formation of enhanced parts made from both the sheet material and one or more patterned regions of deposited structural material (e.g. the added structural material may provide for tip material made from a distinct tip material and bonding regions made from a distinct bonding material. Planarization operations may be used to set layer levels or as intermediate processing steps as necessary.

Group 3 Methods:

In a third group of embodiments a plurality of parts may be produced by processing a sheet of structural material with at least one deposited structural material layer formed on the backside of the sheet of structural material and a bridging sacrificial material layer formed on the last of deposited structural materials with EDM occurring from the front side to cut out part outlines while leaving the individual parts still joined by bridging sacrificial material layer:

Example Pre-EDM, EDM, and post-EDM operations are similar to those noted above mutatis mutandis.

Group 4 Methods:

In a fourth group of embodiments a plurality of parts may be produced by processing a sheet of structural material with at least one multi-material layer formed on the front side of the sheet of structural material with EDM occurring from the front side to cut out part outlines while leaving the individual parts still joined by a bridging sacrificial material formed on the backside of the sheet.

Example Pre-EDM, EDM, and post-EDM operations are similar to those noted above mutatis mutandis.

Group 5 Methods:

In a fifth group of embodiments a plurality of parts may be produced by processing a sheet of structural material with at least one deposited structural material layer formed on the front side of the sheet of structural material and a bridging sacrificial material layer formed on the back side of the sheet with EDM occurring from the front side to cut out part outlines while leaving the individual parts still joined by bridging sacrificial material layer:

Example Pre-EDM, EDM, and post-EDM operations are similar to those noted above mutatis mutandis.

Group 6 Methods:

In a sixth group of embodiments a plurality of parts may be produced by processing a sheet of structural material with at least one multi-material layer formed on the front side of the sheet of structural material, at least one multi-material layer or single material layer formed on the back side of the sheet and with EDM occurring from the front side to cut out part outlines while leaving the individual parts still joined by sacrificial material in the backside multi-material layer or in a bridging sacrificial material layer formed on the backside of the single material layer.

Example Pre-EDM, EDM, and post-EDM operations are similar to those noted above mutatis mutandis.

Group 7 Methods:

In a seventh group of embodiments a plurality of parts may be produced by processing at least one sheet of structural material with at least one deposited structural material layer formed on the front side of the sheet of structural material and a bridging sacrificial material layer formed on the back side of the sheet with EDM occurring from the front side to cut out part outlines while leaving the individual parts still joined by bridging sacrificial material layer:

Example Pre-EDM, EDM, and post-EDM operations are similar to those noted above mutatis mutandis.

Group 8 Methods:

In an eighth group of embodiments a plurality of parts may be produced by processing a multi-layer stack of materials including at least one first sheet layer of structural material and at least two layers selected from the group consisting of: (1) a second sheet layer of structural material, (2) at least one deposited multi-material layer, (3) at least one deposited single material layer, and (4) at least one bridging sacrificial material layer as a final layer opposite to an EDM processing direction, wherein the order of stacking of the layers is selected from the group consisting of (1) the at least two layers are below the structural sheet material, (2) the at least two layers are above the structural sheet material layer, (3) a portion of the at least two layers are above the sheet material and a portion of the at least two layers are below the sheet material, (4) multiple layers of at least one type are used and are separated by a layer of another type, (5) multiple layer of at least one type are used and are adjacent to one another.

Example Pre-EDM, EDM, and post-EDM operations are similar to those noted above mutatis mutandis.

Group 9 Methods:

In an ninth group of embodiments a single part or a plurality of parts may be produced by processing a single layer or multiple layers of one or more materials where patterning occurs at least in part using an EDM electrode and more preferably an EDM electrode that include a plurality of spaced electrode regions wherein at least a portion of the plurality define different copies of the same structure or part to be formed or copies of a plurality of different structures or parts to be formed. In some variations, the electrode may be a plurality of electrically distinct electrodes that may be driven by different electrical sources or semi-isolated electric sources. In some embodiments the single layer or multiple layers may include a sheet or foil material that is supplied in that form while in other embodiments, no such foil or sheet material may be supplied but where the one or more layers to be processed are formed by depositing or otherwise forming selected materials.

Further Comments and Conclusions

While it is clear that the major elements of a number of embodiments have been set forth above, embodiments may involve additional steps, elements, or features that will be understood by those of skill in the art (e.g. cleaning steps; activation steps; alignment steps; repair steps; photoresist deposition, exposure, development, stripping; planarization, alignment, and the like). In some embodiments, in addition to or instead retaining part-to-part connection via the bridging layer, tabs may exist on the perimeters of parts or to structural material frames. Those of skill in the art may select appropriate EDM processing parameters to provide effective cutting via experience or via empirical testing.

In some embodiments, structural or sacrificial dielectric materials may be incorporated into embodiments of the present invention in a variety of different ways. Such materials may form one of the materials of a multi-material layer or the material of a single deposited or sheet material layer. Additional teachings concerning the formation of structures on dielectric substrates and/or the formation of structures that incorporate dielectric materials into the formation process and possibility into the final structures as formed are set forth in a number of patent applications filed Dec. 31, 2003. The first of these filings is U.S. Patent Application No. 60/534,184 which is entitled “Electrochemical Fabrication Methods Incorporating Dielectric Materials and/or Using Dielectric Substrates”. The second of these filings is U.S. Patent Application No. 60/533,932, which is entitled “Electrochemical Fabrication Methods Using Dielectric Substrates”. The third of these filings is U.S. Patent Application No. 60/534,157, which is entitled “Electrochemical Fabrication Methods Incorporating Dielectric Materials”. The fourth of these filings is U.S. Patent Application No. 60/533,891, which is entitled “Methods for Electrochemically Fabricating Structures Incorporating Dielectric Sheets and/or Seed layers That Are Partially Removed Via Planarization”. A fifth such filing is U.S. Patent Application No. 60/533,895, which is entitled “Electrochemical Fabrication Method for Producing Multi-layer Three-Dimensional Structures on a Porous Dielectric”. Additional patent filings that provide teachings concerning incorporation of dielectrics into the EFAB process include U.S. patent application Ser. No. 11/139,262, filed May 26, 2005, now U.S. Pat. No. 7,501,328, by Lockard, et al., and which is entitled “Methods for Electrochemically Fabricating Structures Using Adhered Masks, Incorporating Dielectric Sheets, and/or Seed Layers that are Partially Removed Via Planarization”; and U.S. patent application Ser. No. 11/029,216, filed Jan. 3, 2005 by Cohen, et al., now abandoned, and which is entitled “Electrochemical Fabrication Methods Incorporating Dielectric Materials and/or Using Dielectric Substrates”. These patent filings are each hereby incorporated herein by reference as if set forth in full herein.

Some embodiments may employ diffusion bonding or the like to enhance adhesion between successive layers of material (e.g. sheet-to-sheet, deposit-to-deposit, sheet-to-deposit, or deposit-to-sheet). Various teachings concerning the use of diffusion bonding in electrochemical fabrication processes are set forth in U.S. patent application Ser. No. 10/841,384 which was filed May 7, 2004 by Cohen et al., now abandoned, which is entitled “Method of Electrochemically Fabricating Multilayer Structures Having Improved Interlayer Adhesion” and which is hereby incorporated herein by reference as if set forth in full. This application is hereby incorporated herein by reference as if set forth in full.

Though the embodiments explicitly set forth herein have considered multi-material layers to be formed one after another. In some embodiments, it is possible to form structures on a layer-by-layer basis but to deviate from a strict planar layer on planar layer build up process in favor of a process that interlaces material between the layers. Such alternative build processes are disclosed in U.S. application Ser. No. 10/434,519, filed on May 7, 2003, now U.S. Pat. No. 7,252,861, entitled Methods of and Apparatus for Electrochemically Fabricating Structures Via Interlaced Layers or Via Selective Etching and Filling of Voids. The techniques disclosed in this referenced application may be combined with the techniques and alternatives set forth explicitly herein to derive additional alternative embodiments. In particular, the structural features are still defined on a planar-layer-by-planar-layer basis but material associated with some layers is formed along with material for other layers such that interlacing of deposited material occurs. Such interlacing may lead to reduced structural distortion during formation or improved interlayer adhesion. This patent application is herein incorporated by reference as if set forth in full.

The patent applications and patents set forth below are hereby incorporated by reference herein as if set forth in full. The teachings in these incorporated applications can be combined with the teachings of the instant application in many ways: For example, enhanced methods of producing structures may be derived from some combinations of teachings, enhanced structures may be obtainable, enhanced apparatus may be derived, and the like.

| U.S. patent application No., Filing Date | |
|---|---|
| U.S. application Pub. No. Pub Date | |
| U.S. Pat. No., Pub Date | Inventor, Title |
| 09/493,496 - Jan. 28, 2000 | Cohen, “Method For Electrochemical Fabrication” |
| U.S. Pat. No. 6,790,377 - Sep. 14, 2004 | |
| 10/677,556 - Oct. 1, 2003 | Cohen, “Monolithic Structures Including Alignment and/or |
| 2004-0134772 - Jul. 15, 2004 | Retention Fixtures for Accepting Components” |
| 10/830,262 - Apr. 21, 2004 | Cohen, “Methods of Reducing Interlayer Discontinuities in |
| 2004-0251142A - Dec. 16, 2004 | Electrochemically Fabricated Three-Dimensional Structures” |
| U.S. Pat. No. 7,198,704 - Apr. 3, 2007 | |
| 10/271,574 - Oct. 15, 2002 | Cohen, “Methods of and Apparatus for Making High Aspect |
| 2003-0127336A - Jul. 10, 2003 | Ratio Microelectromechanical Structures” |
| U.S. Pat. No. 7,288,178 - Oct. 30, 2007 | |
| 10/697,597 - Dec. 20, 2002 | Lockard, “EFAB Methods and Apparatus Including Spray |
| 2004-0146650A - Jul. 29, 2004 | Metal or Powder Coating Processes” |
| 10/677,498 - Oct. 1, 2003 | Cohen, “Multi-cell Masks and Methods and Apparatus for |
| 2004-0134788 - Jul. 15, 2004 | Using Such Masks To Form Three-Dimensional Structures” |
| U.S. Pat. No. 7,235,166 - Jun. 26, 2007 | |
| 10/724,513 - Nov. 26, 2003 | Cohen, “Non-Conformable Masks and Methods and |
| 2004-0147124 - Jul. 29, 2004 | Apparatus for Forming Three-Dimensional Structures” |
| U.S. Pat. No. 7,368,044 - May 6, 2008 | |
| 10/607,931 - Jun. 27, 2003 | Brown, “Miniature RF and Microwave Components and |
| 2004-0140862 - Jul. 22, 2004 | Methods for Fabricating Such Components” |
| U.S. Pat. No. 7,239,219 - Jul. 3, 2007 | |
| 10/841,100 - May 7, 2004 | Cohen, “Electrochemical Fabrication Methods Including Use |
| 2005-0032362 - Feb. 10, 2005 | of Surface Treatments to Reduce Overplating and/or |
| U.S. Pat. No. 7,109,118 - Sep. 19, 2006 | Planarization During Formation of Multi-layer Three- |
| | Dimensional Structures” |
| 10/387,958 - Mar. 13, 2003 | Cohen, “Electrochemical Fabrication Method and |
| 2003-022168A - Dec. 4, 2003 | Application for Producing Three-Dimensional Structures |
| | Having Improved Surface Finish“ |
| 10/434,494 - May 7, 2003 | Zhang, “Methods and Apparatus for Monitoring Deposition |
| 2004-0000489A - Jan. 1, 2004 | Quality During Conformable Contact Mask Plating |
| | Operations” |
| 10/434,289 - May 7, 2003 | Zhang, “Conformable Contact Masking Methods and |
| 2004-0065555A - Apr. 8, 2004 | Apparatus Utilizing In Situ Cathodic Activation of a |
| | Substrate” |
| 10/434,294 - May 7, 2003 | Zhang, “Electrochemical Fabrication Methods With |
| 2004-0065550A - Apr. 8, 2004 | Enhanced Post Deposition Processing” |
| 10/434,295 - May 7, 2003 | Cohen, “Method of and Apparatus for Forming Three- |
| 2004-0004001A - Jan. 8, 2004 | Dimensional Structures Integral With Semiconductor Based |
| | Circuitry” |
| 10/434,315 - May 7, 2003 | Bang, “Methods of and Apparatus for Molding Structures |
| 2003-0234179 A - Dec. 25, 2003 | Using Sacrificial Metal Patterns” |
| U.S. Pat. No. 7,229,542 - Jun. 12, 2007 | |
| 10/434,103 - May 7, 2004 | Cohen, “Electrochemically Fabricated Hermetically Sealed |
| 2004-0020782A - Feb. 5, 2004 | Microstructures and Methods of and Apparatus for |
| U.S. Pat. No. 7,160,429 - Jan. 9, 2007 | Producing Such Structures” |
| 10/841,006 - May 7, 2004 | Thompson, “Electrochemically Fabricated Structures Having |
| 2005-0067292 - May 31, 2005 | Dielectric or Active Bases and Methods of and Apparatus for |
| | Producing Such Structures” |
| 10/434,519 - May 7, 2003 | Smalley, “Methods of and Apparatus for Electrochemically |
| 2004-0007470A - Jan. 15, 2004 | Fabricating Structures Via Interlaced Layers or Via Selective |
| U.S. Pat. No. 7,252,861 - Aug. 7, 2007 | Etching and Filling of Voids” |
| 10/724,515 - Nov. 26, 2003 | Cohen, “Method for Electrochemically Forming Structures |
| 2004-0182716 - Sep. 23, 2004 | Including Non-Parallel Mating of Contact Masks and |
| U.S. Pat. No. 7,291,254 - Nov. 6, 2007 | Substrates” |
| 10/841,347 - May 7, 2004 | Cohen, “Multi-step Release Method for Electrochemically |
| 2005-0072681 - Apr. 7, 2005 | Fabricated Structures” |
| 60/533,947 - Dec. 31, 2003 | Kumar, “Probe Arrays and Method for Making” |
| 60/534,183 - Dec. 31, 2003 | Cohen, “Method and Apparatus for Maintaining Parallelism |
| | of Layers and/or Achieving Desired Thicknesses of Layers |
| | During the Electrochemical Fabrication of Structures” |
| 11/733,195 - Apr. 9, 2007 | Kumar, “Methods of Forming Three-Dimensional Structures |
| 2008-0050524 - Feb. 28, 2008 | Having Reduced Stress and/or Curvature” |
| 11/506,586 - Aug. 8, 2006 | Cohen, “Mesoscale and Microscale Device Fabrication |
| 2007-0039828 - Feb. 22, 2007 | Methods Using Split Structures and Alignment Elements” |
| U.S. Pat. No. 7,611,616 - Nov. 3, 2009 | |
| 10/949,744 - Sep. 24, 2004 | Lockard, “Three-Dimensional Structures Having Feature |
| 2005-0126916 - Jun. 16, 2005 | Sizes Smaller Than a Minimum Feature Size and Methods |
| U.S. Pat. No. 7,498,714 - Mar. 3, 2009 | for Fabricating” |

Though various portions of this specification have been provided with headers, it is not intended that the headers be used to limit the application of teachings found in one portion of the specification from applying to other portions of the specification. For example, it should be understood that alternatives acknowledged in association with one embodiment, are intended to apply to all embodiments to the extent that the features of the different embodiments make such application functional and do not otherwise contradict or remove all benefits of the adopted embodiment. Various other embodiments of the present invention exist. Some of these embodiments may be based on a combination of the teachings herein with various teachings incorporated herein by reference.

It is intended that the aspects of the invention set forth herein represent independent invention descriptions which Applicant contemplates as full and complete invention descriptions that Applicant believes may be set forth as independent claims without need of importing additional limitations or elements from other embodiments or aspects set forth herein for interpretation or clarification other than when explicitly set forth in such independent claims once written. It is also understood that any variations of the aspects set forth herein represent individual and separate features that may be individually added to independent claims or dependent claims to further define an invention being claimed by those respective dependent claims should they be written.

In view of the teachings herein, many further embodiments, alternatives in design and uses of the embodiments of the instant invention will be apparent to those of skill in the art. As such, it is not intended that the invention be limited to the particular illustrative embodiments, alternatives, and uses described above but instead that it be solely limited by the claims or by claims that may be presented hereafter or be filed in one or more continuation or divisional applications that may be filed hereafter.

We claim:

1. A method for the batch formation of a plurality of micro-scale or millimeter-scale parts, comprising:
a) obtaining at least one EDM electrode representing a layout of the parts to be formed;
b) providing a sheet of structural material having a front side and a backside;
c) locating a bridging sacrificial material on to the backside of the sheet of structural material;
d) preparing the sheet of structural material and the bridging sacrificial material for EDM processing;
e) using the at least one EDM electrode to erode or cut selected portions of the sheet so that structural material remains having a configuration of the plurality of parts and such that the plurality of parts remain in place with respect to one another due at least to the presence of the bridging sacrificial material; and
f) removing the bridging sacrificial material.

2. The method of claim 1 wherein the bridging sacrificial material comprises a metal.

3. The method of claim 1 wherein the locating of the bridging material on the sheet of structural material comprises electrodepositing the bridging sacrificial material on the sheet of structural material.

4. The method of claim 1 wherein a complete perimeter of each part is cut through the sheet of structural material by the at least one EDM electrode.

5. The method of claim 1 wherein at least a portion of the plurality of parts remain tethered to one another or to a structural material frame by tabs of structural sheet material after completion of EDM processing and wherein the tabs are removed after removing the bridging sacrificial material.

6. The method of claim 1 wherein a layer of a deposited structural material is formed on the front side of the sheet of structural material prior to EDM processing and the EDM processing erodes or cuts through the deposited and sheet structural materials.

7. The method of claim 1 wherein selective regions of deposited structural material are formed on the front side of the sheet of structural material prior to EDM processing and the EDM processing cuts completely through the deposited and sheet structural materials.

8. The method of claim 1 wherein selective regions of deposited structural material are formed on the front side of the sheet of structural material prior to EDM processing and the EDM processing cuts completely through the sheet structural material but doesn't contact the deposited structural material and wherein the parts formed comprise regions of deposited structural material and sheet structural material.

9. The method of claim 1 wherein at least one multi-material layer comprised of at least one structural material and at least one sacrificial material is formed on the front side of the sheet of structural material prior to EDM processing and the EDM operations cut through part of the deposited structural material and sacrificial material of the at least one multi-material layer and the sheet structural material.

10. The method of claim 1 wherein at least one multi-material layer comprised of at least one structural material and at least one sacrificial material is formed on the front side of the sheet of structural material prior to EDM processing and the EDM processing cuts through only the deposited sacrificial material of the at least one multi-material layer and the sheet structural material.

11. The method of claim 1 wherein after the EDM processing that cuts through the sheet of structural material, a sacrificial material is deposited to fill in the eroded regions of the sheet material and thereafter additional structural material is deposited.

12. The method of claim 11 wherein the additional structural material is deposited as part of at least one multi-material layer that each include at least one structural material and at least one sacrificial material.

13. The method of claim 12 wherein after depositing the additional structural material, at least one additional EDM operation is performed to cut through at least a portion of the additional deposited material.

14. The method of claim 1 wherein prior to obtaining the EDM electrode, the EDM electrode is s fabricated using an electrochemical deposition process.

15. The method of claim 1 wherein parts comprise probes for use in a device selected from the group consisting of (1) a probe card that in turn is used for wafer level testing of semiconductor devices and (2) an electrical connector, wherein the probes comprise a tip material that is different from a material of the body of the probes or pins.

16. The method of claim 1 wherein the preparing comprises attaching the bridging sacrificial material to a frame.

17. The method of claim 1 wherein the at least one EDM electrode comprises a single electrode array that includes a plurality of difference purpose electrodes that are serially stacked including at least two electrodes selected from the group consisting of (1) at least one drilling electrode to form through passages, (2) at least one rough cutting electrode that results in regions that approximate the shape of the parts but does not create part boundaries, and (3) at least one finish electrode that provides for part boundaries.

18. A method for the batch formation of a plurality of micro-scale or millimeter-scale parts, comprising:
a) obtaining at least one EDM electrode representing a layout of the parts to be formed;
b) providing a sheet of structural material having a front side and a backside;
c) forming at least one multi-material electrochemically fabricated layer on the backside of the sheet of structural material, wherein the at least one multi-material layer comprises at least one structural material and at least one sacrificial material;
d) preparing the sheet of structural material and at least one backside multi-material layer for EDM processing;
e) using the at least one EDM electrode to erode or cut selected portions of the sheet so that structural material remains having a configuration of the plurality of parts and such that the plurality of parts remain in place with respect to one another due at least to the presence of the at least one sacrificial material of the at least one backside multi-material layer; and
f) removing the sacrificial material.

19. A method for the batch formation of a plurality of micro-scale or millimeter-scale parts, comprising:
a) obtaining at least one EDM electrode representing a layout of the parts to be formed;
b) providing a sheet of structural material having a front side and a backside;
c) forming at least one multi-material electrochemically fabricated layer on the backside of the sheet of structural material, wherein the at least one multi-material layer comprises at least one structural material and at least one sacrificial material;
d) locating a bridging sacrificial material on to the backside of the at least one multi-material layer;
e) preparing the sheet of structural material, the at least one multi-material layer and the bridging sacrificial material for EDM processing;
f) using the at least one EDM electrode to erode or cut selected portions of the sheet and multi-material layer so that structural material remains having a configuration of the plurality of parts and such that the plurality of parts remain in place with respect to one another due at least to the presence of the bridging sacrificial material; and
g) removing the sacrificial material forming part of the at least one multi-material layer and removing bridging sacrificial material.

20. A method for the batch formation of a plurality of micro-scale or millimeter-scale parts, comprising:
a) obtaining at least one EDM electrode representing a layout of the parts to be formed;
b) providing a sheet of structural material having a front side and a backside;
c) forming at least one structural material layer on the backside of the sheet of structural material;
d) locating a bridging sacrificial material on to the backside of the formed structural material layer;
e) preparing the sheet of structural material, the formed structural material layer, and the bridging sacrificial material for EDM processing;
f) using the at least one EDM electrode to erode or cut selected portions of the sheet and the formed structural material layer so that structural material remains having a configuration of the plurality of parts and such that the plurality of parts remain in place with respect to one another due at least to the presence of the bridging sacrificial material; and
g) removing bridging sacrificial material.

21. A method for the batch formation of a plurality of micro-scale or millimeter-scale parts, comprising:
a) obtaining at least one EDM electrode representing a layout of the parts to be formed;
b) providing a sheet of structural material having a front side and a backside;
c) locating and attaching at least two layers directly or indirectly to the sheet of structural material, wherein the at least two layers are selected from the group consisting of (1) a second sheet layer of structural material, (2) at least one deposited multi-material layer, (3) at least one deposited single material layer, and (4) at least one bridging sacrificial material layer as a final layer opposite to an EDM processing direction; wherein the positioning order of stacking of the layers is selected from the group consisting of (1) the at least two layers are below the structural sheet material, (2) the at least two layers are above the structural sheet material layer, (3) a portion of the at least two layers are above the sheet material and a portion of the at least two layers are below the sheet material, (4) multiple layers of at least one type are used and are separated by a layer of another type, (5) multiple layers of at least one type are used and are adjacent to one another.
d) preparing the sheet of structural material and the located and attached layers for EDM processing;
e) using the at least one EDM electrode to erode or cut selected portions of the sheet and the at least two other layers so that structural material remains having a configuration of the plurality of parts and such that the plurality of parts remain in place with respect to one another due at least to the presence of a sacrificial material; and
f) removing sacrificial material.
